(19) United States
(12) Patent Application Publication
(10) Pub. No.: US 2011/0113082 A1
(43) Pub. Date: May 12, 2011

(54) SIGNAL FILTERING AND FILTER DESIGN TECHNIQUES

(76) Inventors: Amirhossein Alimohammad, Edmonton (CA); Saeed Fouladi Fard, Edmonton (CA); Bruce Fordyce Cockburn, Esmonton (CA); Christian Schlegel, Park City, UT (US)

(21) Appl. No.: 12/449,432

(22) PCT Filed: Feb. 7, 2008
(86) PCT No.: PCT/US08/01601

§ 371 Date: Nov. 29, 2010

Related U.S. Application Data
(60) Provisional application No. 60/888,630, filed on Feb. 7, 2007.

(51) Int. Cl. G06F 17/10

(52) U.S. Cl. 708/316; 708/300

(57) ABSTRACT

Signal filtering and filter design techniques are disclosed. An interconnection circuit switchably couples an input and an output of an element that is operable to perform a signal filtering operation on a signal received at the input so as to provide a filtered signal at the output. This enables the element to be used to implement a series of cascaded signal filtering operations. An iterative filter design method and a data structure that enables control of the element and/or the interconnection circuit are also disclosed. According to another aspect of the invention, an element is operable to perform any of multiple signal filtering operations on a received input signal. Controlled selection of respective sets of filter parameters associated with the multiple signal filtering operations enables the element to be used to implement the signal filtering operations in parallel filtering paths.

### FIELD OF THE INVENTION

This invention relates generally to signal processing and, in particular, to filtering of electronic signals.

### BACKGROUND

The design of wireless communication systems often involves simulation of radio propagation characteristics, mainly Rayleigh fading. Successful implementation of wireless products typically requires prototyping and broad field testing. A reliable yet less costly approach is to model the behavior of radio channels on a channel emulator or simulator. With the widespread use of multiple antenna wireless communications systems, it can be necessary to simultaneously emulate multiple propagation channels.

Two major techniques have been widely used for simulating Rayleigh fading channels. In the first approach, the Rayleigh fading process is modeled as a superposition of a plurality of sinusoidal waves. This approach was originally proposed by Clarke [1] and later modified by Jakes [2]. Although during the past decades several modifications have been proposed [3]-[10], generating fading variates with accurate statistics and low complexity remains quite challenging [11], [12] with this technique.

Another approach for channel simulation is to first generate a complex, zero-mean, Gaussian random process with independent samples. The random variates are then passed through a spectrum shaping filter (SSF). In order to generate complex Rayleigh fading variates, the shaping filter has to be designed with a frequency response equal to the square root of the Jakes' power spectral density (PSD). This approach, called the filter-based method, can provide the accurate statistical properties for simulating fading channels [13].

The shaping filter is bandlimited to a relatively small normalized Doppler rate f_{D}Tₛ, where f_{D} denotes the maximum Doppler frequency and Tₛ is the symbol period. For high symbol transmission rate systems, f_{D}Tₛ can be quite small and thus the bandwidth of the shaping filter becomes much narrower than the bandwidth of the transmitted signal. This in turn increases the minimum required order of the shaping filter that ensures a relatively accurate response. To achieve the desired accuracy with a computationally-feasible low-order filter, it is common to design the shaping filter in a lower sampling frequency and later interpolate the generated signal to achieve the target sampling rate. To reduce the computational complexity of the low-pass filters, interpolation is usually accomplished using a multi-stage interpolator design.

Due to the high computational complexity of these high-precision filters, a parameterizable Rayleigh fading simulator might not be able to fit on one field-programmable gate array (FPGA) device and thus might require multiple devices [14]. For example, the fading simulator in [15] uses a floating point DSP (to implement the random number generator, Doppler spectrum shaping filter, and the first-stage interpolator) combined with an FPGA (to implement the final interpolation stage and other required components) to realize a frequency-selective channel simulator. The design in [14] also uses two 32-bit floating-point DSPs to implement a multipath fading simulator. This problem is even more severe when implementing a multiple-input multiple-output (MIMO) channel with n_{T} transmitter antennas and n_{R} receiving antennas. A MIMO communication system requires n_{T}×n_{R} different Rayleigh fading channels. Similarly, in the case of a frequency-selective channel, typically 6≦Lₚₐₜₕ≦48 independent resolvable paths are considered to simulate a frequency-selective channel.

Thus, there remains a need for improved filters and filtering techniques, which could be used in fading channel simulation and/or other applications.

### SUMMARY OF THE INVENTION

According to an aspect of the invention, a signal filtering apparatus comprises an element having an input and an output, the element being operable to perform a signal filtering operation on a signal received at the input so as to provide a filtered signal at the output, and an interconnection circuit operatively coupled to the element, the interconnection circuit being controllable to switchably couple the input with the output, to thereby enable the element to be used to implement a series of cascaded signal filtering operations.

In some embodiments, the series of cascaded signal filtering operations comprises one or more of: a zero-padding operation, an upsampling operation, and a downsampling operation.

In some embodiments, the element is operable to perform any of a plurality of different signal filtering operations, and the series of cascaded signal filtering operations comprises at least two different-signal filtering operations of the plurality of different signal filtering operations.

In some embodiments, the different signal filtering operations are associated with respective sets of one or more filter parameters, and the element comprises a memory for storing the respective sets of filter parameters.

In some embodiments, the element is controllable to perform a particular signal filtering operation of the plurality of different signal filtering operations by storing to the memory the set of filter parameters associated with the particular signal filtering operation.

In some embodiments, the plurality of different signal filtering operations comprises a first signal filtering operation associated with a spectrum shaping filter (SSF) and a second filtering operation associated with a low-pass filter (LPF).

In some embodiments, a filtering process of the SSF comprises repeating the first filtering operation a number of times, and a filtering process of the LPF comprises repeating the second signal filtering operation a number of times.

In some embodiments, the SSF operates at a sample rate Fₛ₁ and the LPF operates at a sample rate Fₛ₂ that is an integral multiple, I₁, of Fₛ₁, and the element is used to perform the second signal filtering operation I₁ times for each time the element is used to perform the first signal filtering operation.

In some embodiments, the SSF and the LPF are operable to together provide desired filtering characteristics.

In some embodiments, the element comprises a filter second-order section (SOS) or filter first-order section hardware (FOSH).

In some embodiments, the element and the interconnection circuit are controlled in accordance with software instructions.

In some embodiments, the software instruction comprises a count field and a mode field, the mode field specifying whether or not a wait operation during which a value in the count field is to be counted down to zero is to be executed, and the count field comprising at least one of: an opcode field specifying an operation to be executed when a wait operation is not to be executed, a program counter field specifying a program counter value, a multiplexer select field for specifying multiplexer select lines, a multiplier number identifying a multiplier, a biquad number identifying a biquad, and a filter number identifying a filter.

In some embodiments, the interconnection circuit comprises a multiplexer operatively coupled to receive the filtered signal and an input signal, and to provide the input signal or the filtered signal to the input of the element.

In some embodiments, the apparatus is implemented onto a Field Programmable Gate Array (FPGA).

In some embodiments, a fading communication channel emulator comprises such an apparatus and a Gaussian variate generator (GVG) operatively coupled to the interconnection circuit.

In some embodiments, the fading channel emulator further comprises a low-pass filter operatively coupled to the apparatus, the low-pass filter being operable to further filter an output of the apparatus.

In some embodiments, the low-pass filter comprises a number of zero-order hold filters.

A fading channel emulator may also include an elastic buffer between the apparatus and the low-pass filter.

In some embodiments, a fading channel emulator includes a plurality of low-pass filters operatively coupled together in series and to the apparatus, the plurality of low-pass filters being operable to further filter an output of the apparatus, and a respective elastic buffer operatively coupled to an output of each low-pass filter of the plurality of low-pass filters.

The apparatus and the plurality of low-pass filters exchange handshaking information in some embodiments.

A signal filtering method according to another aspect of the invention involves providing an element that is operable to generate a filtered signal by performing a signal filtering operation on a signal received at an input, and selecting, from a set of signals comprising a filter input signal and the filtered signal, an input to the element, to enable the element to be used to perform a series of cascaded signal filtering operations.

In some embodiments, the set of signals further comprises a zero signal, and the series of cascaded signal filtering operations comprises one or more of: a zero-padding operation, an upsampling operation, and a downsampling operation.

In some embodiments, the element is operable to perform any of a plurality of different signal filtering operations, and the series of cascaded signal filtering operations comprises at least two different signal filtering operations of the plurality of different signal filtering operations.

In some embodiments, the different signal filtering operations are associated with respective sets of one or more filter parameters, and the method further comprises selecting a particular signal filtering operation of the plurality of different signal filtering operations, and providing to the element the set of filter parameters associated with the particular signal filtering operation.

In some embodiments, the plurality of different signal filtering operations comprises a first signal filtering operation associated with an SSF and a second filtering operation associated with an LPF.

In some embodiments, a filtering process of the SSF comprises repeating the first filtering operation a number of times, and a filtering process of the LPF comprises repeating the second signal filtering operation a number of times.

In some embodiments, the element comprises a filter SOS or filter FOSH.

In some embodiments, selecting comprises selecting an input from the set of signals in accordance with a software instruction.

In some embodiments, the filter input signal comprises a series of samples generated by a GVG.

In some embodiments, the method further comprises providing an output of the series of cascaded filtering operations to a low-pass filter.

Another aspect of the invention provides a method comprising designing a signal filter to implement a desired filter frequency response, and performing an iterative optimization procedure on the signal filter to achieve an acceptable level of similarity between an actual frequency response of the signal filter and the desired filter frequency response.

In some embodiments, designing comprises selecting a number of filter sections for the signal filter, and the iterative optimization procedure comprises changing the number of filter sections.

In some embodiments, the signal filter comprises multiple cascaded signal filters, designing comprises selecting a common number of filter sections for each of the multiple filters, and the iterative optimization procedure comprises changing the common number of filter sections.

In some embodiments, the signal filter is associated with filter parameters, and the iterative optimization procedure comprises adjusting the filter parameters.

In some embodiments, adjusting the filter parameters comprises calculating the filter parameters using Algorithm 1 below.

A computer-readable medium storing a data structure is also provided. The data structure comprises a plurality of data fields storing control information for controlling operation of at least one of: an element that is operable to generate a filtered signal at an output by performing a signal filtering operation on a signal received at an input, and an interconnection circuit that is operatively coupled to the element for switchably coupling the input with the output. The data field identifying the element and a data field indicating an operation to be performed by the element.

In some embodiments, the plurality of data fields comprises a data field identifying a component of the interconnection circuit and a data field indicating an operation to be performed by the identified component.

In some embodiments, the plurality of data fields comprises a mode data field, the mode data field indicating how other data fields of the plurality of data fields are to be processed.

A further aspect of the invention provides a signal filtering apparatus comprising an element having an input and an output, the element being operable to perform any of a plurality of signal filtering operations on a signal received at the input, the plurality of signal filtering operations being associated with respective sets of filter parameters, and a controller operatively coupled to the element and operable to control selection of the respective sets of filter parameters for use by the element, to thereby enable the element to be used to implement the plurality of signal filtering operations in respective parallel filtering paths.

The plurality of signal filtering operations and the respective sets of filter parameters may correspond to respective communication signal propagation paths.

The apparatus may also include a memory, operatively coupled to the element and to the controller, for storing the respective sets of filter parameters. The controller may then control selection of the respective sets of filter parameters by controlling addresses in the memory from which filter parameters are provided to the element.

A plurality of elements are operatively coupled together in series in some embodiments. The elements may be operatively coupled together through elastic buffers. In some embodiments, each element of the plurality of elements is operatively coupled to a respective controller, and the controller of an element is operatively coupled to, and exchanges handshaking information with, a controller of each adjacent element.

A signal filtering method according to another aspect of the invention involves providing an element that is operable to perform any of a plurality of signal filtering operations on a signal received at an input, the plurality of signal filtering operations being associated with respective sets of filter parameters, and controlling selection of the respective sets of filter parameters for use by the element, to thereby enable the element to be used to implement the plurality of signal filtering operations in respective parallel filtering paths.

Where the respective sets of filter parameters are stored in a memory, controlling may involve controlling selection of the respective sets of filter parameters by controlling addresses in the memory from which filter parameters are provided to the element.

The operation of providing may involve providing a plurality of elements, including the element, operatively coupled together in a series of stages, in which case the method may also include exchanging handshaking information between the stages. Controlling at each stage following a first stage in the series may then involve controlling selection of the respective sets of filter parameters based on handshaking information received from a preceding stage.

Other aspects and features of embodiments of the present invention will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 is a plot of an example filter frequency response used for interpolation in high sample rates.

FIG. 2 includes plots showing the autocorrelation and cross-correlation between real and imaginary parts of an example generated fading process against theoretical statistics.

FIG. 3 shows an example level crossing rate (LCR) plot for generated fading samples against theoretical statistics.

FIG. 4 is a plot of an example probability density function (pdf) for the amplitude of generated samples versus theoretical statistics.

FIG. 5 plots the magnitude of the frequency response of an example spectrum shaping filter (SSF) and a theoretical reference.

FIG. 6 shows correlation properties of real and imaginary components of another example fading process against theoretical statistics.

FIG. 7 shows example plots of LCR for isotropic and nonisotropic scattering channel examples and theoretical statistics.

FIG. 8 is a block diagram of a fading channel simulator.

FIG. 9 is a block diagram of the datapath of a biquad.

FIG. 10 is a block diagram showing a datapath of a real filter processor (RFP).

FIG. 11 is a block diagram of an exemplary 32-bit microinstruction format for a filter processor.

FIG. 12 is a block diagram of a datapath of first-order section hardware (FOSH).

FIG. 13 shows a frequency response of an example shaping filter with 6 cascaded second-order sections.

FIG. 14 shows a frequency response of an example first stage interpolation low-pass filter.

FIG. 15 shows an example control flow graph for a shaping filter and interpolation filter datapath of a fading channel emulator.

FIG. 16 shows an example time-multiplexed shaping filter and interpolation filter datapath.

FIG. 17 shows the autocorrelation between real and imaginary parts of another example generated fading process against theoretical statistics.

FIG. 18 shows an example LCR plot for generated fading samples versus theoretical statistics.

FIG. 19 is a plot of an example pdf for generated fading variates against theoretical statistics.

FIG. 20 is a symbol error rate (SER) plot for an example fading channel emulator for two different modulation schemes.

FIG. 21 is a block diagram of another example filter-based fading channel emulator.

FIG. 22 shows a frequency response of an example elliptic shaping filter.

FIG. 23 shows another example of a time-multiplexed shaping filter and interpolation filter datapath.

FIG. 24 is a block diagram of an example fading simulator in which an embodiment of the invention may be implemented.

FIG. 25 is a block diagram of a fading simulator according to an embodiment of the invention.

FIG. 26 is a block diagram of the architecture of an example biquad processor according to another embodiment of the invention.

FIG. 27 is a block, diagram of an example fading-specific interpolation lowpass filter (SILPF).

FIG. 28 is a block diagram of an example tapped delay generator for three-path fading.

FIG. 29 shows a plot of autocorrelation and cross-correlation between real and imaginary components of a generated fading process with f_{D}=0.6 Hz and Fₛ=2.5 MHz over 60 seconds.

FIG. 30 shows a plot of probability density function and FIG. 31 shows an example LCR plot for a generated fading process with f_{D}=200 Hz and Fₛ=10 MHz.

### DETAILED DESCRIPTION OF PREFERRED EMBODIMENTS

As described in further detail below, embodiments of the present invention propose new filtering and filter design techniques for such applications as modeling Rayleigh fading channels. Iterative techniques are also proposed for designing minimum phase Infinite Impulse Response (IIR) filters with complex coefficients that can be used, for example, to design spectrum shaping filters in simulation of fading channels with nonisotropic scattering propagation. A specific type of filtering for interpolation can significantly decrease hardware complexity without sacrificing accuracy.

Illustrative examples of flexible and compact filter processors may be used to efficiently implement the shaping filter and interpolation low-pass filters on a small fraction of a single FPGA. A parameterized Rayleigh fading channel simulator can be configured to emulate various radio propagation characteristics. The ability to implement an entire fading channel emulator on a fraction of a single FPGA could be a significant improvement for the prototyping and verification of wireless systems.

### Filter Design for a Fading Channel Simulator

In a realistic wireless channel, samples of a Rayleigh process are temporally correlated. The correlation properties depend on the antenna characteristic, propagation environment and, on the Doppler frequency resulting from relative motion between receiver and transmitter. The description below considers the illustrative example of a MIMO system with enough spacing between antennas at both transmit and receiver sides so that the received samples would be spatially uncorrelated. However, introducing spatial correlation between generated samples is straightforward [16].

With no spatial correlation, wireless paths between each pair of transmit and receive antennas experience a fading process independent of other paths. This reduces the simulation of the MIMO wireless channel to generation of n_{T}×n_{R} independent Rayleigh fading processes. We also assume that the delay spread of the wireless channel, τ_{D} is much smaller than the sampling time Tₛ so that the behaviour of the wireless channel can be considered as flat-fading. Extension of frequency-flat channel simulator to frequency-selective channels with Lₚₐₜₕ resolvable paths each with propagation delay τₗ is straightforward. A brief review of the model of a fading channel is presented below, followed by a description of how to design filters in accordance with embodiments of the invention to generate the fading process and/or for other applications.

### A. Introduction

Multipath propagation is the situation where a received signal contains different faded copies of a transmitted signal. The effect of the multipath fading on a baseband signal can be modeled with a time-variant linear system with the impulse response [13]

$$α ( τ ; t ) = {\sum }_{n = 0}^{{N}_{p} - 1} {μ}_{n} \vert {c}_{n} ( t ) \vert {e}^{j∠ {c}_{n} ( t )} δ ( τ - {τ}_{n} ( t ) ) , \qquad ( 1 )$$

where Nₚ is the number of independent paths, μₙ is the average attenuation of the n-th path, and cₙ(t) and τₙ(t) denote the complex gain and delay of the n-th path. In an isotropic scattering Rayleigh fading channel, the path gains can be modeled using a unit-variance zero-mean complex. Gaussian process cₙ(t)=cₙ^{I}(t)+jcₙ^{Q}(t) [17] with the power spectral density (PSD) function

$${S}_{{c}_{n}} ( f ) = \{ \begin{matrix}\frac{1}{π \sqrt{{f}_{{D}_{n}}^{2} - {f}^{2}}} & if \vert f \vert < {f}_{{D}_{n}} \\ 0 & otherwise\end{matrix} \qquad ( 2 )$$

where f_{Dn} is the maximum Doppler frequency of the n-th path. In this model, cₙ^{I}(t) and cₙ^{Q}(t) are independent stochastic processes that have the same autocorrelation function (ACF) R_{c}_{ₙ}(t)=Jₒ(2πf_{Dn}τ), where Jₒ(•) is the zeroth-order Bessel function of the first kind [2]. Assuming the above model, the level-crossing rate of |cₙ(t)| is N_{R}_{ₙ}(λ)=\sqrt{2π}f_{Dn}λe^{-λ}^{²} [31], where λ=Rₜₕ/Rᵣₘₛ is the specified threshold level Rₜₕ normalized to the rms value of the magnitude.

To simulate a Rayleigh fading channel according to an embodiment of the invention, a sequence of complex path gains {cₙ(t)} is generated and then delayed replicas of transmitted samples with the given delays {τₙ(t)} and path attenuation {μₙ(t)} are superimposed. The path gains with desired statistics may be generated, for example, by passing a stream of independent Gaussian samples through an SSF, as described above. For the case of Rayleigh fading, the SSF has a magnitude response equal to the square root of the magnitude of the Jakes' spectrum given in (2).

When a line-of-sight (LOS) component is present, the channel is called Rician. In Rician propagation, the complex sum of all paths has a nonzero mean path gain that can be divided into two components. The first component is the LOS part with average power |βₙ|²≦1 and the second component is the random scattering part with average power 1−|βₙ|². For the n-th path (possibly between an antenna pair), the Rician factor Kₙ is defined as

$${K}_{n} = \frac{{\vert {β}_{n} \vert}^{2}}{1 - {\vert {β}_{n} \vert}^{2}} .$$

For pure Rayleigh fading channels, βₙ=0 and hence Kₙ=0; for Rician channels |βₙ|>0 and hence Kₙ>0. To simulate Rician propagation, one can generate {cₙ(t)} with the PSD given in (2) and then attenuate the samples by \sqrt{1−|βₙ|²} to obtain the power of the random scattering component. The total complex path gain can then be obtained by adding the sinusoidal Rician component.

Following the Gaussian wide-sense stationary (WSS) uncorrelated scattering model [17], [18], the fading process is commonly modeled as a complex Gaussian process c(t)=cᵣ(t)+jcᵢ(t). The second-order statistics of c(t) are affected by relative motion between transmitter and receiver, antenna characteristics and the propagation geometry. We consider the general case of nonisotropic Rayleigh fading [19] where the angle of arrival (AOA), θ, is distributed with the parametric von Mises distribution

$${p}_{Θ} ( θ ) = \frac{exp ⌊ κ cos ( θ - {θ}_{p} ) ⌋}{2 π {I}_{o} ( κ )} , θ ∈ [ - π , π ] \qquad ( 3 )$$

where Iₙ(•) is the n-th order modified Bessel function of the first kind [20], θₚε[−π,π) is the average direction of AOA, and κ≧0 controls the bandwidth associated with AOA. Note that when κ=0, θ is uniformly distributed over [−π,π) (i.e., isotropic scattering condition) while κ=∞ results in p_{Θ}(θ)=δ(θ−θₚ), which corresponds to highly nonisotropic scattering (i.e., extremely directional antennas). The autocorrelation function (ACF) of the fading process corresponding to the AOA distribution in Equation 1 is [19]

$$\begin{matrix}{R}_{cc} ( τ ) = E \{ c ( t ) {c ( t - τ )}^{*} \} \\ = {R}_{{c}_{r} {c}_{r}} ( τ ) + j {R}_{{c}_{r} {c}_{i}} ( τ ) \\ = \frac{{I}_{0} ( \sqrt{{κ}^{2} - 4 {π}^{2} {f}_{D}^{2} {τ}^{2} + 4 jκ cos ( {θ}_{p} ) π {f}_{D} τ} )}{{I}_{0} ( κ )}\end{matrix} \qquad ( 4 )$$

where R_{c}_{ᵣ}_{c}_{ᵣ}(τ)=R_{c}_{ᵢ}_{c}_{ᵢ}(τ), R_{c}_{ᵣ}_{c}_{ᵣ}(τ) and R_{c}_{ᵢ}_{c}_{ᵢ}(τ) denote the ACF of real and imaginary parts of c(t), and R_{c}_{ᵣ}_{c}_{ᵢ}(τ) denotes the cross-correlation function (CCF) of cᵣ(t) and cᵢ(t). Note that for κ=0, Equation (4) reduces to the ACF of Clark's two-dimensional isotropic scattering reference R_{cc}(τ)=J₀(j2πf_{D}τ) where Jₒ(•) is the zeroth-order Bessel function. The corresponding power spectral density (PSD) to Equation (4) is given by [19]

$$\begin{matrix}{S}_{c} ( f ) = \frac{1}{π {f}_{D} \sqrt{1 - {( f / {f}_{D} )}^{2}}} \times \frac{exp ( κ cos ( {θ}_{p} ) f / {f}_{D} ) cosh ( κ sin ( {θ}_{p} ) \sqrt{1 - {( f / {f}_{D} )}^{2}} )}{{I}_{0} ( κ )} & ( 5 ) \\ \vert f \vert \leq {f}_{D} & \end{matrix}$$

where for the case κ=0, Equation (5) reduces to the well-known U-shaped Jakes' PSD s_{c}(f)=(π²(f_{D}²−f²))^{-1/2}, |f|<f_{D}. It is important to note that when employing directional antennas, the non-uniform distribution of AOA at. the receiver results in a baseband PSD that is not symmetric around f=0 anymore (in baseband). For a Rayleigh fading channel with nonisotropic scattering, it can be shown [21] that the level crossing rate (LCR) is

$$L ( ρ ) = \sqrt{2 π} {f}_{D} ρ exp ( - {ρ}^{2} ) \times \frac{\sqrt{{I}_{0}^{2} ( κ ) - {I}_{1}^{2} ( κ ) + cos ( 2 {θ}_{p} ) [ {I}_{0} ( κ ) {I}_{2} ( κ ) - {I}_{1}^{2} ( κ ) ]}}{{I}_{0} ( κ )} \qquad ( 6 )$$

which for the special case κ=0 reduces to \sqrt{2π}f_{D}ρexp(−ρ²). A method for designing filters to generate the fading process with the above statistical properties is described below.

### B. IIR Filter Design

The fading process is generated in one embodiment by passing the independent samples of a zero-mean complex Gaussian process with unit power through a spectrum shaping filter (SSF) with a magnitude response equal to the square root of the magnitude of Equation (5). In practice, since f_{D} is much smaller than the sample rate Fₛ, the designed SSF would have an extremely narrow bandwidth and a very sharp cut-off. The complexity of the SSF can be reduced by designing it at a lower sample rate, which also improves the accuracy of the designed filter. Further, the generated samples are interpolated to attain the required sampling frequency. The SSF is designed with an IIR filter in some embodiments, since it results in lower orders than a finite impulse response (FIR) counterpart. Moreover, since only the amplitude response affects the correlation properties and no restrictions are imposed on the phase response, elliptic IIR filters can be used for interpolation stages.

Through numerical simulation, it was found that an SSF with a maximum of 0.5 dB ripple in the passband and a transition band not exceeding seven percent of the maximum Doppler frequency was accurate enough to generate a fading process with desired correlation properties. Also, an SSF with minimum attenuation of 80 dB in the stopband can provide acceptable LCR.

According to embodiments of the invention, the filters are designed in two stages. The first stage is the SSF with the magnitude response

$$H ( {e}^{- j ω} ) = A {\prod }_{k = 1}^{2 K} \frac{1 - {r}_{k} {e}^{j ( {θ}_{k} - ω )}}{1 - {s}_{k} {e}^{j ( {φ}_{k} - ω )}} \qquad ( 7 )$$

where A is a positive scaling factor, rₖe^{jθ}^{ₖ} and sₖe^{jφ}^{ₖ} are the kth complex zero and pole, and 2K is the number of first-order sections (FOSs). When κ=0, poles and zeros of Equation (7) appear in complex conjugate pairs and the shaping filter can be implemented using K canonical second-order sections (SOSs), also known as biquads.

The second stage includes an upsampler and an IIR elliptic low-pass filter (LPF). For practical reasons (reducing the complexity of a filter processor's controller), it would be desirable if the second stage low-pass filter has as many second-order sections as the SSF, although the SSF and LPF need not necessarily have the same number of sections.

In one embodiment, the SSF is designed at the sampling frequency Fₛ₁ and the LPF is designed at the sampling frequency Fₛ₂=I₁×Fₛ₁ where I₁ is a positive integer. Note that Fₛ₂ could be chosen to be equal to Fₛ. However, for realistic applications, designing the filters in more than two stages results in significantly lower computational complexity. Accurate statistical properties are maintained by an LPF that provides more than 80 dB attenuation in the stopband and has a total passband ripple not exceeding 0.5 dB. Also, to achieve lower computational complexity, the corner frequency of the interpolation LPF can be selected to be as low as f_{D}.

### C. Filter Design for High-Rate Interpolators

Low-pass filtering after each stage of upsampling suppresses image frequency components. In conventional fading simulators, this is normally done by using conventional FIR or IIR filters. However, this results in high computational complexity and increase in the hardware size due to excessive use of multiplications. Multiplication-free filters can help to reduce the complexity and increase the efficiency of this stage.

For the cases where the maximum Doppler frequency is much smaller than the sample rate, some embodiments of the present invention use a cascade of l_{z} zero-order hold filters with impulse response dₚ(n)=[P⁻¹, P⁻¹, . . . , P⁻¹]_{1×P} where P is the upsampling rate. The frequency response of this filter is given by

$${D}_{P} ( {e}^{- j w} ) = {( \frac{1 - {e}^{- jω P}}{P - P {e}^{- jω}} )}^{{l}_{z}} \qquad ( 8 )$$

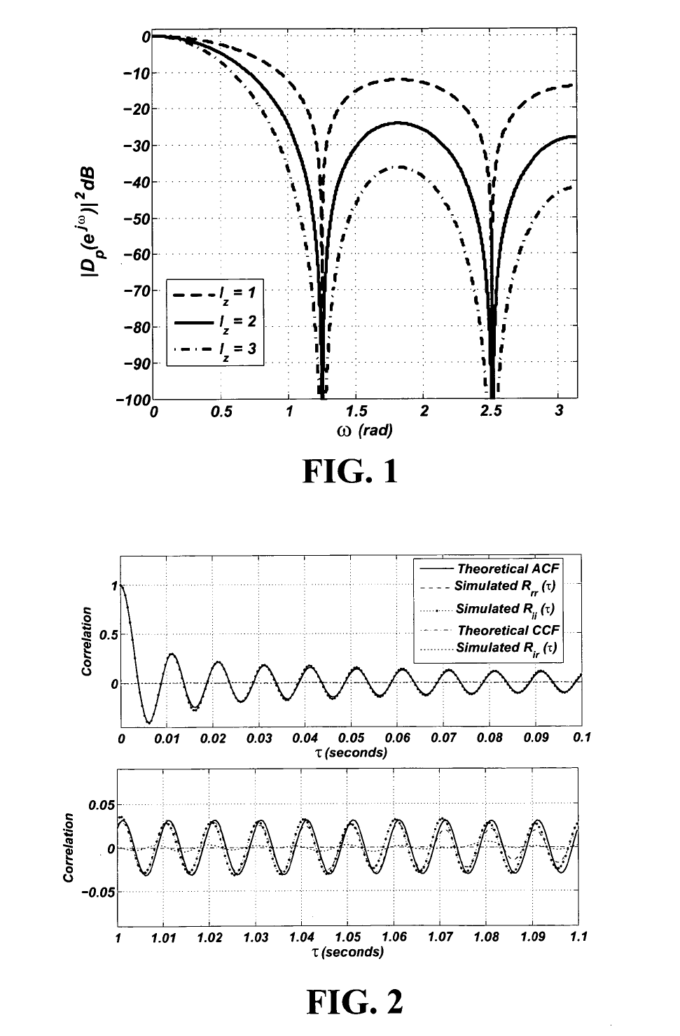

which has exactly P−1 zeros at image frequencies. FIG. 1 is a plot of an example filter frequency response.

For the case f_{D}/Fₛ≦0.02, this filter can provide more than 80 dB attenuation on the image signals with l_{z}=2 cascaded sections. Different variations of this filter can be efficiently mapped onto hardware using only addition and shift operations.

It should be appreciated that FIG. 1 represents an example only, and that other filters may exhibit different characteristics than shown. For instance, increasing the number of cascaded sections would result in more attenuation of the image components as well as wider notches at each image signal.

### Iterative Design of Spectrum Shaping Filter

According to embodiments of the invention, the SSF and LPF are designed in an iterative fashion. First, the design process starts with an initial small K and the LPF is designed with the corner frequency f_{D}, stop frequency 1.07×f_{D}, maximum passband ripple Rₚ^{l}, and minimum stopband attenuation of Rₛ^{l}. Second, the SSF is designed with a maximum passband ripple Rₚ^{s}, and minimum stopband attenuation Rₛ^{s}. Now, if Rₚ=Rₚ^{s}+Rₚ^{l}≦0.5 dB and Rₛ=Rₛ^{s}+Rₛ^{l}≧80 dB, thereby achieving acceptable similarity between the actual frequency response of the SSF/LPF cascade signal filter and the desired frequency response, it is possible that the design is complete. Otherwise, K can be increased and the process is repeated from the first step.

For the case κ=0 (isotropic scattering), since the PSD of the fading process is symmetric and the SSF filter coefficients are real, one can use the procedure proposed in [23]. It can be more convenient to use an appropriate software package and function. However, these techniques are not appropriate for designing complex filters required for the nonisotropic case. A filter design procedure is proposed herein for minimum-phase and stable complex IIR filters. A weight vector v=[v₁, v₂, . . . , v_{2M}]^{T} is also introduced to enable emphasis of error minimization on certain frequency bands of a designed filter.

To design the SSF in one embodiment, 2×M frequency points are defined in the interval uᵢε[−0.5,+0.5] and an attempt is made to fit the frequency response of SSF to the sampled desired response yᵢ^{d}=\sqrt{|S(e^{-2jπu}^{ᵢ})|}, where S(•) is the PSD of the sampled fading process. Frequency samples at uᵢ=(2i+1−2M)/(4M), i=0, . . . , 2M−1 are selected so that samples at the corner frequencies have appropriate values. The column vector x of length 8K is defined, containing rₖ, Sₖ, θₖ and φₖ. The quantity H(e^{-jω}) can then be expressed as H(e^{-jω})=A×F(x,e^{-jω) where F(x,e}^{-jω}) represents the product of FOSs in Equation 5. Next, to find the filter parameters, a cost function can be defined

$$q ( A , x ) = {\sum }_{i = 0}^{2 M - 1} {{v}_{i} ( log ( A \vert F ( x ; {e}^{- jω} ) \vert ) - log ( {y}_{i}^{d} ) )}^{2} + B ( L ; t ; x ) \qquad ( 9 )$$

which includes the error squares in logarithmic scale in addition to the parametric barrier function B(L;t;x). The barrier function B(L;t;x) is added to the main cost function in order to keep the poles and zeros within the unit circle (i.e., stable and minimum phase) and is defined as

$$\begin{matrix}B ( L , t , x ) = {\sum }_{k = 1}^{4 K} b ( L ; t ; {x}_{k} ) & ( 10 ) \\ where & \\ b ( L ; t ; {x}_{k} ) = \{ \begin{matrix}0 & if \vert {x}_{k} \vert \leq t , \\ {L ( \frac{\vert {x}_{k} \vert - t}{1 - t} )}^{2} & if t < \vert {x}_{k} \vert \leq 1 , \\ \frac{2 L}{1 - t} \vert {x}_{k} \vert - L ( \frac{1 + t}{1 - t} ) & if \vert {x}_{k} \vert \geq 1.\end{matrix} & ( 11 )\end{matrix}$$

In Equation 8, the parameter t is set as an outer boundary for poles and zeros. In addition, L determines how fast the barrier function grows outside of the unit circle. The coefficients of the SSF are found in an iterative fashion. In each iteration, first the optimum scaling factor A^{o} is calculated as

$${A}^{o} = {\prod }_{i = 0}^{2 M - 1} {( \frac{{y}_{i}^{d}}{\vert F ( x ; {e}^{- j2π {u}_{i}} ) \vert} )}^{\frac{{v}_{i}}{{\sum }_{i = 0}^{2 M - 1} {v}_{i}}} \qquad ( 12 )$$

which is found by differentiating Equation (9) with respect to A and setting it to zero. Further, the gradient vector

$$g ( {A}^{o} , x ) = {[ \frac{\partial q ( {A}^{o} , x )}{\partial {x}_{1}} , … , \frac{\partial q ( {A}^{o} , x )}{\partial {x}_{8 K}} ]}^{T}$$

is found from

$$\frac{\partial q ( {A}^{o} , x )}{\partial {x}_{k}} = 2 {\sum }_{i = 0}^{2 M - 1} [ \frac{{v}_{i} log ( \frac{{A}^{o} \vert F ( x ; {e}^{- {jω}_{i}} ) \vert}{{y}_{i}^{d}} )}{\vert F ( x ; {e}^{- {jω}_{i}} ) \vert} ] \frac{\partial \vert F ( x ; {e}^{{jω}_{i}} ) \vert}{\partial {x}_{k}} + \frac{\partial B ( L ; t ; x )}{\partial {x}_{k}} \qquad ( 13 )$$

where ωᵢ=2πuᵢ and each partial derivative is given by

$$\begin{matrix}\frac{\partial B ( L ; t ; x )}{\partial {x}_{k}} = \{ \begin{matrix}0 & if \vert {x}_{k} \vert \leq t or k > 4 K , \\ \frac{2 L \vert {x}_{k} \vert - t}{{( 1 - t )}^{2}} sign ( {x}_{k} ) & if t < \vert {x}_{k} \vert \leq 1 and k \leq 4 K , \\ \frac{2 L}{1 - t} sign ( {x}_{k} ) & if \vert {x}_{k} \vert \geq 1 and k \leq 4 K .\end{matrix} & ( 14 ) \\ \frac{\partial \vert F ( x ; {e}^{- jω} ) \vert}{\partial {r}_{k}} = \vert F ( x ; {e}^{- jω} ) \vert \frac{{r}_{k} - cos ( {θ}_{k} - ω )}{{\vert 1 - {r}_{k} {e}^{j ( {θ}_{k} - ω )} \vert}^{2}} & ( 15 ) \\ \frac{\partial \vert F ( x ; {e}^{- jω} ) \vert}{\partial {θ}_{k}} = \vert F ( x ; {e}^{- jω} ) \vert \frac{{r}_{k} sin ( {θ}_{k} - ω )}{{\vert 1 - {r}_{k} {e}^{j ( {θ}_{k} - ω )} \vert}^{2}} & ( 16 ) \\ \frac{\partial \vert F ( x ; {e}^{- jω} ) \vert}{\partial {s}_{k}} = \vert F ( x ; {e}^{- jω} ) \vert \frac{cos ( {φ}_{k} - ω ) - {s}_{k}}{{\vert 1 - {s}_{k} {e}^{j ( {φ}_{k} - ω )} \vert}^{2}} & ( 17 ) \\ \frac{\partial \vert F ( x ; {e}^{- jω} ) \vert}{\partial {φ}_{k}} = \vert F ( x ; {e}^{- jω} ) \vert \frac{- {s}_{k} sin ( {φ}_{k} - ω )}{{\vert 1 - {s}_{k} {e}^{j ( {φ}_{k} - ω )} \vert}^{2}} . & ( 18 )\end{matrix}$$

From here, an iterative algorithm can be used to find the filter coefficients. In one embodiment, we use the Ellipsoid algorithm [24]. Algorithm 1 below summarizes the steps for an illustrative example iterative filter optimization. Other embodiments may use different implementations than explicitly shown below for Algorithm 1.

Algorithm 1: Iterative calculation of filter coefficients
$Require \text{:} t ; L ; v = [ {v}_{i} ] , {y}^{d} = [ {y}_{i}^{d} ] , i = 0 … 2 M - 1$ $Initialize k = 0 , {x}_{0} , {E}_{0} = 20 {I}_{8 K \times 8 K}$ $while not converged do$ $find {A}_{k}^{o} from ( 12 )$ $find {g}_{k} = g ( {A}_{k}^{o} , {x}_{k} ) from ( 13 )$ ${β}_{k} = \sqrt{{g}_{k}^{T} {E}_{k} {g}_{k}}$ ${\tilde{g}}_{k} = {g}_{k} / {β}_{k}$ ${x}_{k + 1} = {x}_{k} - \frac{1}{8 K + 1} {E}_{k} {\tilde{g}}_{k}$ ${E}_{k + 1} = \frac{{( 8 K )}^{2}}{{( 8 K )}^{2} - 1} ( {E}_{k} - \frac{2}{8 K + 1} {E}_{k} {\tilde{g}}_{k} {\tilde{g}}_{k}^{T} {E}_{k} )$ $k = k + 1$ $end while$

A weight vector v as well as a vector containing the desired response y^{d}=[yᵢ^{d}] are passed to Algorithm 1. In embodiments in which this algorithm works on a logarithmic scale, all of the elements of y^{d} have positive values. The algorithm starts from a random point x₀ within the initial ellipsoid matrix E₀. The ellipsoid algorithm searches for optimal solution within an ellipsoid of feasible point. This algorithm finds the optimal solution by successively reducing the size of the ellipsoid until it is smaller than a threshold (i.e., the algorithm has converged).

To demonstrate the accuracy of such a filter design procedure, a simulation was performed using a flat Rayleigh fading channel with isotropic scattering, maximum Doppler frequency of f_{D}=100 Hz, and sampling frequency Fₛ=10 MHz (10 million samples per second). Both SSF and LPF were designed with K=6 second-order sections and barrier function parameters t=0.999 and L=5. The sampling frequencies of SSF and LPF were 625 Hz and 15625 Hz respectively. Further, the signal was upsampled and filtered with a number of multiplication free filters (as described above) with P=5 and P=2 and l_{z}=2 until the signal with the sample rate 10 MHz was attained. For a design to be implemented on FPGAs, for example, all of the computations in the SSF and the first stage LPF could be performed with 32-bit fixed-point arithmetic. Also, the consecutive interpolation stages may operate with 16-bit fixed-point variables.

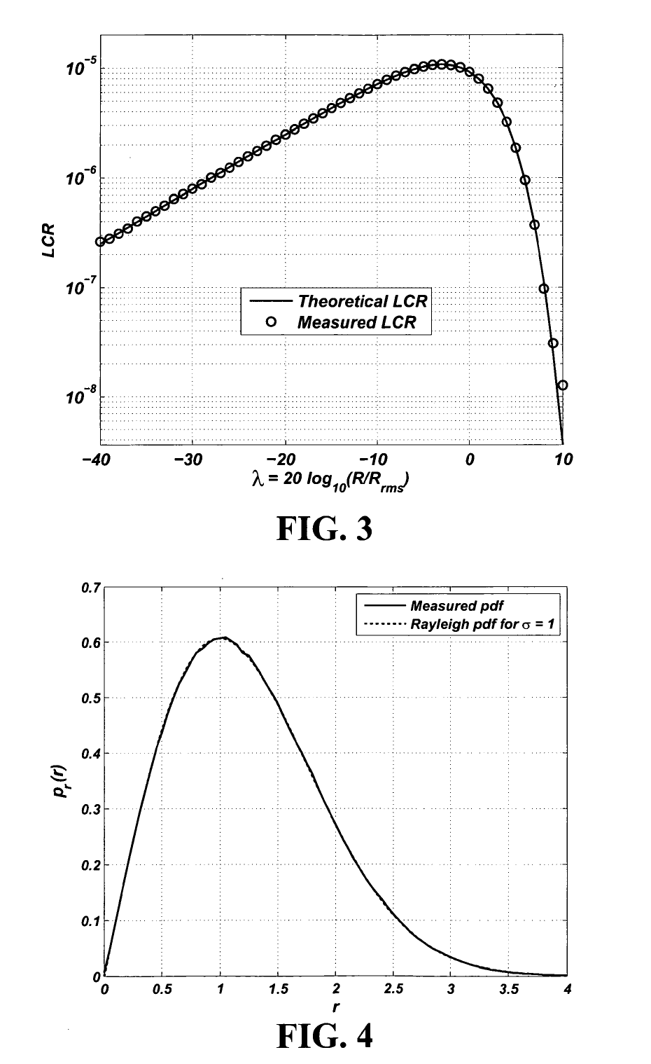

FIG. 2 shows the autocorrelation and cross-correlation between real and imaginary parts of the generated fading process. The theoretical references are plotted as well. The upper part of FIG. 2 shows the correlation up to τ=0.1 seconds, and the lower part plots the same quantities for 1.0≦τ≦1.1. The simulation results presented in FIG. 2, as well as those in FIGS. 3 to 7, were generated using a fixed-point fading channel simulator.

As FIG. 2 shows, there is a close match between the desired statistics and the generated results up to 1.1 seconds (11 million samples).

FIG. 3 shows the LCR of the generated fading samples. This figure also shows a good match between the theoretical LCR and the LCR of generated fading variates.

In FIG. 4, the probability density function (pdf) for the amplitude of the generated fading variates is plotted and it can be observed that this pdf accurately follows the Rayleigh pdf.

As another example, a fading simulator was designed for the case f_{D}=3 KHz. The simulator was designed for both isotropic and nonisotropic scattering with κ=1 and θ=0. Moreover, to design the SSF and the first LPF, K=6 biquads were employed.

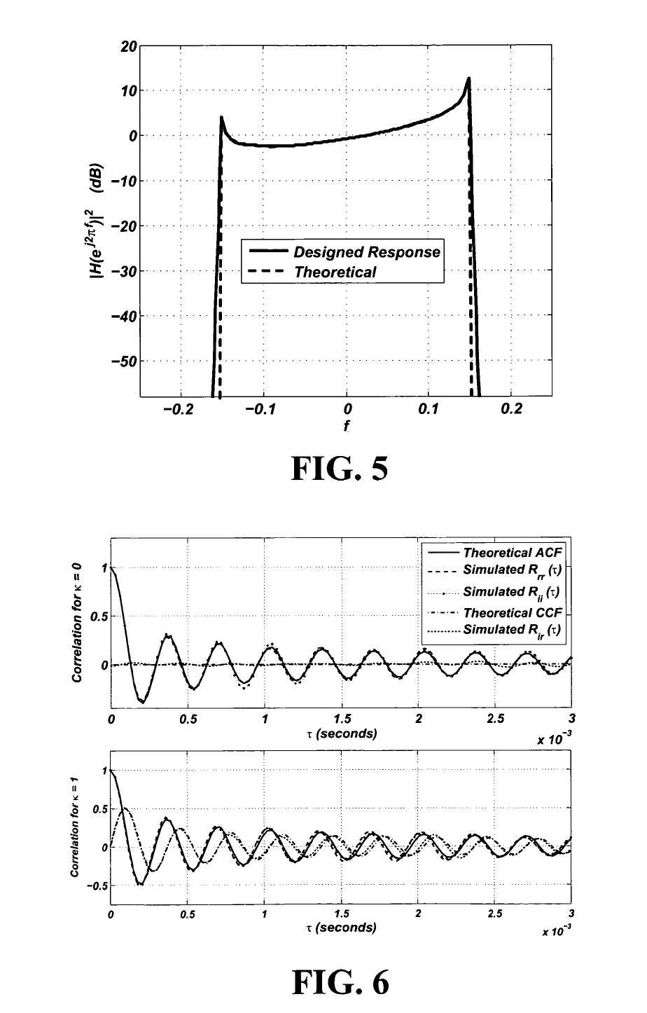

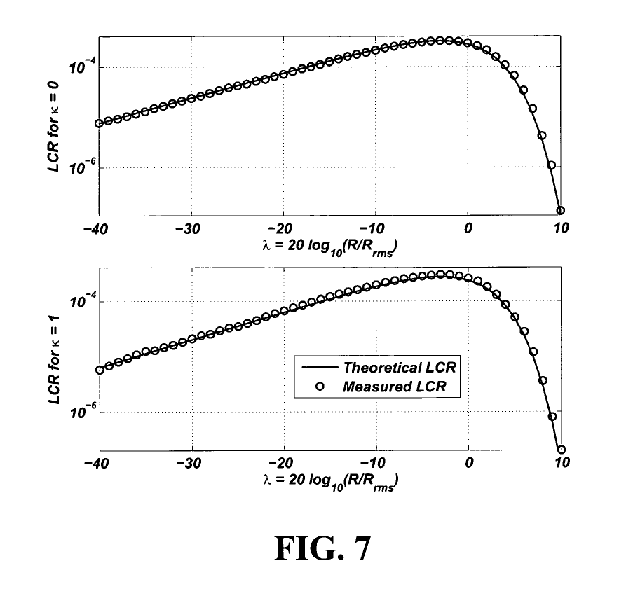

FIG. 5 plots the frequency response of the designed SSF versus the theoretical target for the case κ=1 at sampling frequency Fₛ₁=20 KHz. Further, FIG. 6 shows the correlation properties of a fading process generated using the filters designed in this example. The upper part of FIG. 6 shows the correlation for an isotropic channel (κ=0), and the lower part plots the nonisotropic case with κ=1 and θ=0. Here again a close match is observed for both designed filters. The LCR of a fading process that uses these designed filters is given in FIG. 7, which shows a close match. In FIG. 7, the upper part plots the LCR of the simulated isotropic channel (κ=0) and the lower part plots the same quantity for κ=1 and θ=0.

### Implementation of Fading Channel Emulator

In order to implement a fading channel simulator on an FPGA, a complex Gaussian process with independent samples is generated. The generated samples are passed through the SSF and LPF to provide a low sample rate Rayleigh fading process, which is further upsampled and filtered to attain the target sampling rate. As discussed above, for simulating fading channels with nonisotropic scattering, the SSF is implemented with complex-valued coefficients. However, for the isotropic case, these filter coefficients are real. Compared to an SSF with complex-valued coefficients, this results in a reduction of computational complexity of SSF by a factor of two. Since in practice many applications require running filters with real coefficients, an aspect of the invention provides a new structure called a real filter processor (RFP) for running IIR filters, which is indeed capable of generating a Rayleigh fading process for isotropic scattering. Furthermore, later in the present application, a complex filter processor (CFP) which is capable of running IIR filters with complex coefficients is introduced.

### A. RFP

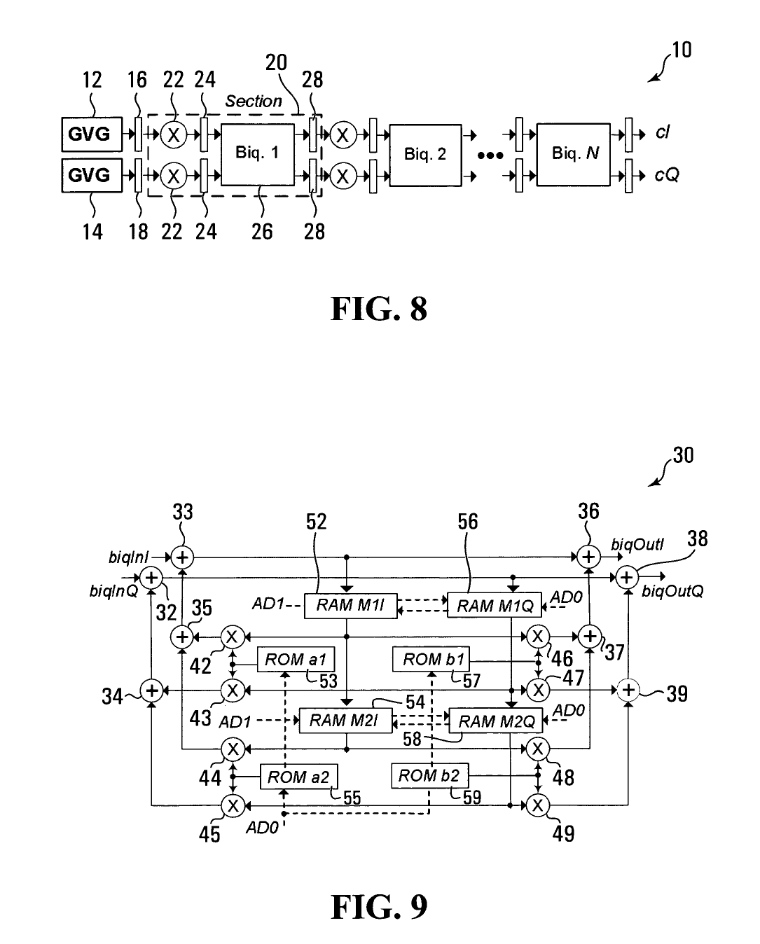

The discussion below assumes that the SSF and interpolation LPF have K and P SOSs respectively. The hardware implementation of an SOS is referred to below as a “biquad”. In a conventional implementation of a fading channel simulator on an FPGA, in addition to two instances of Gaussian variate generators (GVGs), K instances of biquads for the SSF, P instances of biquads for the LPF and 2(K+P) multipliers are required to implement γ=1, . . . , Γ IIR filters in a cascaded structure. FIG. 8 is a block diagram of one such conventional structure 10, which includes two GVGs 12, 14 operatively coupled to two pipeline registers 16, 18, and N=K+P cascaded sections 20. Each cascaded section 20 includes multipliers 22, pipeline registers 24, 28, and a biquad 26, which are interconnected as shown.

The datapath of a biquad in Direct-Form II structure [25] is shown in FIG. 9. The datapath 30 includes adders 32 through 39 and multipliers 42 through 49, which are interconnected with each other and with memory elements 52 through 59 as shown. Four intermediate variables “M1I”, “M1Q”, “M2I”, “M2Q” are stored in the memory elements 52, 56, 54, 58. These memory elements may be four on-FPGA dual-port memories, for example. Four coefficients “a1”, “a2”, “b1”, “b2” of each biquad are stored in the memory elements 53, 55, 57, 59, which may be configured as read-only memories (ROMs), as shown. “AD0” is a read address port for the memory elements 52, 53, 54, 55, 56, 57, 58, 59, and “AD1” is a write address port for the memory elements 52, 54, 56, 58.

Those skilled in the art to which the present application pertains will be familiar with the structures shown in FIGS. 8 and 9 and their operation.

When designing IIR filters in fixed-point representation, the precision of the filters coefficients and also the precision of intermediate signals of the biquads impact the filter response and thus the statistical properties of the generated fading variates. Fixed-point error analysis has confirmed that a 32-bit fixed-point implementation of a fading channel simulator ensures computation accuracy and filter stability. However, to implement a flexible fading channel simulator that supports different small values of normalized Doppler frequencies f_{D}Tₛ, it becomes more challenging to realize the structure in FIG. 8 with high-precision arithmetic components on resource-constrained FPGAs. For example, for a 32-bit realization, just a single section 20 of the structure 10 shown in FIG. 8 uses 855 configurable slices and utilizes 9% of dedicated 18×18-bit multipliers available on one type of commercially available FPGA. This confirms that the maximum number of second-order sections that can be implemented on a large FPGA is only around 11 due to the relatively large number of high-precision arithmetic units required by each biquad.

To efficiently implement a fading channel emulator according to an aspect of the present invention, an RFP was designed to obtain increased and ideally maximum throughput with a reduced and ideally minimum amount of FPGA resources. In this case, the computation of Γ IIR filters (each using N_{γ} cascaded biquads) can be distributed among m=1, . . . , Mᵣ RFPs. Since both the SSF and the LPFs are designed using a cascade structure, resource sharing of independent operations of the SSF and LPF offers significant resource reduction in implementation of computationally-intensive fading channel emulator. The throughput of a fading channel emulator depends on the binding of the SOSs to the RFPs. The sample rate of a digital filter implementation on FPGA is high enough that the throughput reduction of a time-multiplexed scheme compared to a direct instantiation of cascade biquads did not impact the maximum target sampling rate.

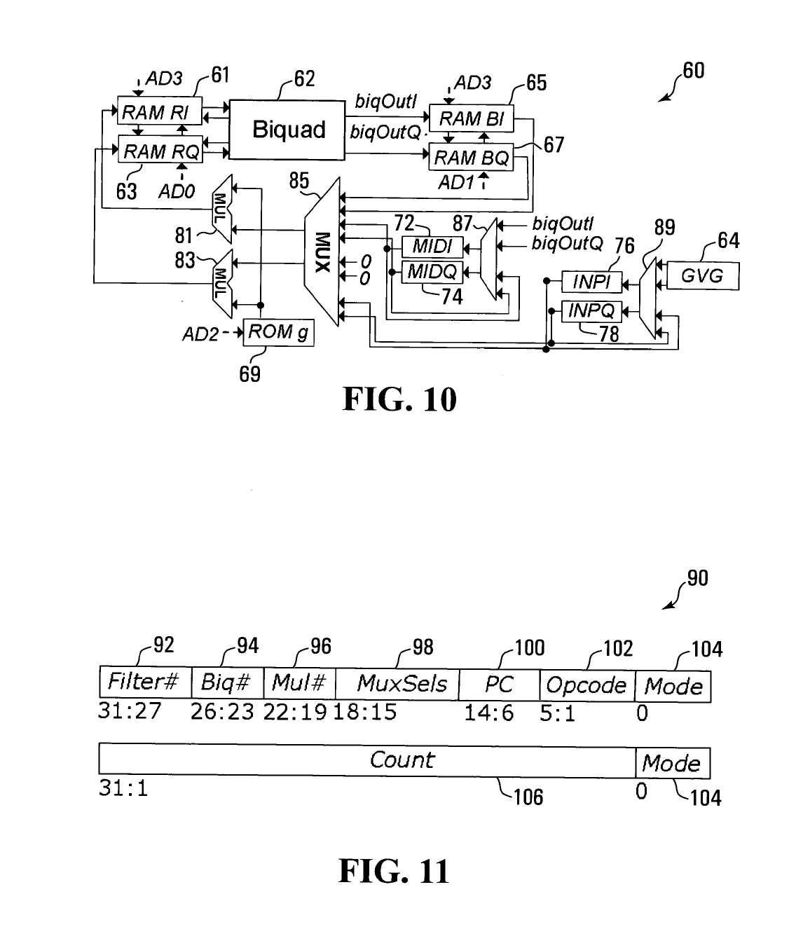

FIG. 10 is a block diagram showing a datapath of an RFP. The core component of the RFP 60 is a biquad 62. The inputs “RI”, “RQ” to the biquad 62 come from two memory elements 61, 63 (for inphase and quadrature parts), illustratively dual-port RAMs, with “AD0” as a read address port and “AD3” as a write address port. The outputs “BI”, “BQ” of the biquad 62 are stored in two other memories 65, 67 with “AD1” as a read address port and “AD3” as a write address port. The memory element 69, which may be a ROM as shown, stores scaling factors g and is initialized using “AD2” read address port. Two combinational multipliers 81, 83 are used to perform the scaling operation of intermediate values between biquads. The GVG 64 generates two independent Gaussian variates per clock cycle. The zero inputs to the 8-input multiplexer 85 are used when the RFP 60 performs a zero-padding operation of interpolators.

In the RFP 60, the biquad 62 is an example of an element that has an input and an output and is operable to perform a signal filtering operation on a signal received at the input to provide a filtered signal at the output. The MUXs 85, 87, 89 are part of an interconnection circuit that is operatively coupled to the biquad 62, and provide for control of the interconnection circuit to switchably couple the input of the biquad with its output to enable the biquad to be used to implement a series of cascaded signal filtering operations, as described in further detail below. Multiplexers 85, 87 and 89 act as routing switches that selectively connect appropriate inputs to the desired outputs to support time-multiplexed operation of filters. Registers 72, 74, store intermediate variables between successive stages of each filter. Registers 76, 78 store the intermediate data from the input.

It should thus be apparent that the interconnection circuit can select an input for the biquad 62 from a set of signals. In the example shown in FIG. 10, this set of signals includes a filter input signal generated by the GVG 64, an output signal from the biquad 62, or a zero signal in the form of the zero inputs to the MUX 85. Selection of a zero signal enables the biquad 62 to be used to perform a zero-padding operation.

Implementation of a control structure for controlling execution of cascaded SSFs and LPFs in an implementation such as shown in FIG. 10 will be straightforward to those skilled in the art. However, when simulating MIMO channels or frequency-selective channels where there are multiple paths, with each path possibly being characterized by different filter specifications, a flexible implementation of a control unit for programming the various filter parameters may become more important.

Rather than designing a control unit using random logic circuitry, an RFP controller may use a microprogramming approach. A code generator written in a high-level programming language, such as C for example, might receive the specification of designed filters and their interconnections as inputs and generate a sequence of microinstructions (microcode) to be executed by an RFP architecture such as 60. This microprogram could be stored in an instruction ROM and addressed by a program counter (PC), for instance. To minimize the resource usage of hardware, the random logic of an instruction decoder could be eliminated by utilizing a horizontal microcode in which every control bit in a microinstruction is used as a control line in an RFP datapath.

An exemplary 32-bit microinstruction format is shown in FIG. 11. The microinstruction format 90 is an example of a data structure that includes 32 bits of control information in various control fields 92, 94, 96, 98, 100, 102 and a mode field 104. In one embodiment, if the “Mode” 104 is “1”, an RFP counts from the value given in the “Count” field 106, which includes the control fields 92, 94, 96, 98, 100, 102, down to zero (wait operation); otherwise it will execute the operation given by the 5-bit “Opcode” field 102. Hence, up to 32 different micro-operations (such as BIQ: execute a biquad operation, MUL: execute a multiplier operation, JMP: jump to an address given by a PC or other controller, RST: reset intermediate registers, etc.) can be defined. The “PC” field 100 denotes a 9-bit program counter value. Four bits are used in the “MuxSels” field 98 as multiplexer select lines. The “Mul#”, “Biq#”, and “Filter#” fields 96, 94, 92 denote a multiplier number, a biquad number, and a filter number, respectively.

The “Mul#” field 96 effectively exploits the commutative properties of computing cascaded second-order sections. The SOS operations can be re-ordered in such a way that a multiplication can be performed simultaneously with a biquad operation. This out-of-order scheduling scheme reduces the required number of clock cycles to execute N cascaded second-order sections from 2N in a sequential scheme down to N.

One important decision to make is how to bind operations of the structure in FIG. 8 into one or more RFPs. Assuming that the memories in an RFP architecture use AL-bit addressing, then up to 2^{AL} different biquad operations can be performed using one biquad in a time-multiplexed scheme. For example, if AL=9, then an RFP can execute 16 IIR filters, each designed with up to 32 cascaded biquads. The maximum number of filters that can be executed with one RFP depends on the size of memory, the number of biquads associated with each filter, and the minimum required throughput. Based on the example microinstruction format shown in FIG. 11 with a 5-bit “Filter#” field 92 and a 4-bit “Biq#” field 94, 2⁵=32 IIR filters each designed with up to 2⁴=16 biquads can be executed with one RFP, but it is straightforward to modify the microinstruction format to support execution of various number of IIR filters, designed with different number of biquads (for example, a 4-bit “Filter#” field 92 and a 5-bit “Biq#” field could support 2⁴=16 filters each designed with up to 2⁵=32 biquads). Due to the slow variation of output samples of an SSF compared to the fast operating rate of biquads implemented on FPGAs, the operation of an SSF and the operation of an LPF can be bound to the same RFP.

### B. CFP

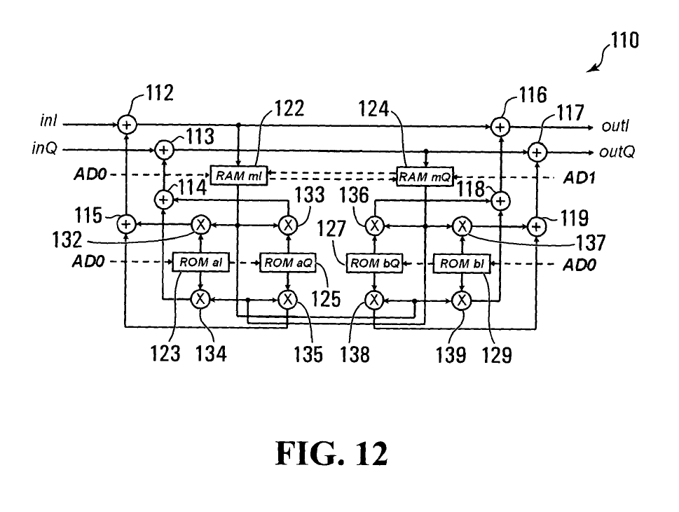

Implementation of a CFP is similar to that of an RFP. In one embodiment of a CFP, the main difference is that, in a CFP instead of a biquad, FOS hardware (FOSH) is instantiated and in each iteration one FOS is executed. FIG. 12 is a block diagram of a datapath of FOSH in Direct-Form II structure [25]. The structure 110 includes adders 112 through 119, multipliers 132 through 139, and memory elements that have been shown as two RAMs 122, 124 and four ROMs 123, 125, 127, 129. In the embodiment shown, two intermediate variables “mI” and “mQ” are stored in two on-chip dual-port memories 122, 124, and two complex coefficients “aI”, “aQ”, “bI”, “bQ” are stored in four ROMs 123, 125, 127, 129. Here again, “AD0” and “AD1” are memory read and write address lines or ports.

Other than the slight difference in core components, the example RFP and CFP shown in FIGS. 10 and 12 use the same number of ROMs, adders, and multipliers but different amounts of RAM. An RFP and a CFP may use different microcode sequences, since a CFP executes FOSs rather than SOSs. It should also be noted that a CFP, and possibly an RFP, may use an additional iteration for performing filtering operations after upsampling.

In terms of processing speeds and capabilities, an RFP can run an IIR filter with real coefficients two times faster than a CFP, but a CFP is capable of running IIR filters with complex coefficients.

### C. Implementation Results

To implement the datapath shown in FIG. 10 for both an RFP and a CFP, a GVG as proposed in [26] was used in one embodiment. This particular example GVG core operates at over 200 MHz and utilizes less than 1% of configurable slices, only two dedicated 18×18-bit multipliers, and two memory blocks provided in one commercially available FPGA. Due to the slower operating rate of the shaping filter compared to the interpolator, only one GVG core was utilized.

On the same FPGA, one example implementation of the biquad datapath shown in FIG. 9 utilized 1% of configurable slices, 7% of dedicated multipliers and 8 on-chip memory blocks, and operated at 63.4 MHz. An example implementation of the RFP datapath in FIG. 10 utilized an additional 2% of the configurable slices, 9% of dedicated multipliers and 14 on-chip memory blocks. A FOSH datapath uses the same amounts of resources as a biquad, with the exception of a lower amount of RAM. One example FOSH datapath implementation used only 6 additional on-chip memory blocks.

The signal outputs of an RFP or CFP processor may be further fed to upsamplers and multiplication-free filters introduced above. For one example system with f_{D}=100 Hz and isotropic propagation, five expansion stages were used with interpolation factors {5,4,4,4,2} to get the sample rate to 10 MHz. With 16-bit precision, these 5 stages can be implemented on one commercially available FPGA to altogether utilize 1% of configurable slices and operate at 200 MHz.

It is important to note that utilizing the special filters introduced above, it is possible to attain higher sample rates by adding additional interpolation stages with slight increase in complexity in terms of hardware resources. For example, by adding two interpolation stages with factors 5 and 4, it is possible to generate 200 million samples per second which only requires 0.7% more of available configurable slices.

In some embodiments, an SSF and the first of two stages of interpolation filters are designed in two steps. In the first step, both the SSF and the first interpolation LPF are designed to meet desired characteristics, and in a second step, the filters are optimized to reduce their hardware complexity. Since only signal amplitudes impact correlation properties, no limitations necessarily need to be imposed on the phase of the target signal. Considering the greater computational efficiency of IIR filters, the Jakes' PSD can be approximated with a rational filter using the least pth-norm approximation [27]. This could be achieved, for example, by utilizing a software function that allows one to specify a weight vector to emphasize error minimization in certain frequency bands. Since the signal has a narrow bandwidth, low-order IIR interpolation low-pass filters (ILPFs) can be used in interpolation stages. In one embodiment, inverse-Chebychev low-pass filters are used for interpolation.

In the next step, the filters can be changed to be mapped onto hardware more efficiently. Since the shaping and first stage interpolation low-pass filters operate at relatively low sampling rates in some embodiments, it can be advantageous to reuse hardware to implement both filters. Employing the cascaded SOS form of IIR filters for both an SSF and an ILPF simplifies hardware sharing. In fact, a biquad can be shared to perform the processing of different SOS parts in the shaping and the first low-pass filter. However, to simplify the control unit, it may be preferable for the two filters to have the same number of SOSs.

To minimize the total number of SOSs in the shaping and the first-stage ILPF, these filters can be optimized together to meet design requirements. For example, in a “discrete” design, the SSF might ideally have a frequency response matched to the Jakes' PSD in the range |f|<4 KHz, and a zero response elsewhere. Also, the first ILPF might ideally pass the signal within the range |f|<10 KHz where the sample rate of the SSF is 20 KHz.

However, with small out-of-band attenuation, the desired statistics of target Rayleigh fading samples might not be met. In particular, the LCR of the envelope of the fading samples is sensitive to the out-of-band attenuation. Designing these two filters “together” may minimize the error in the pass band |f|<4 KHz while maximizing the attenuation in the stopband 4<|f|50 KHz.

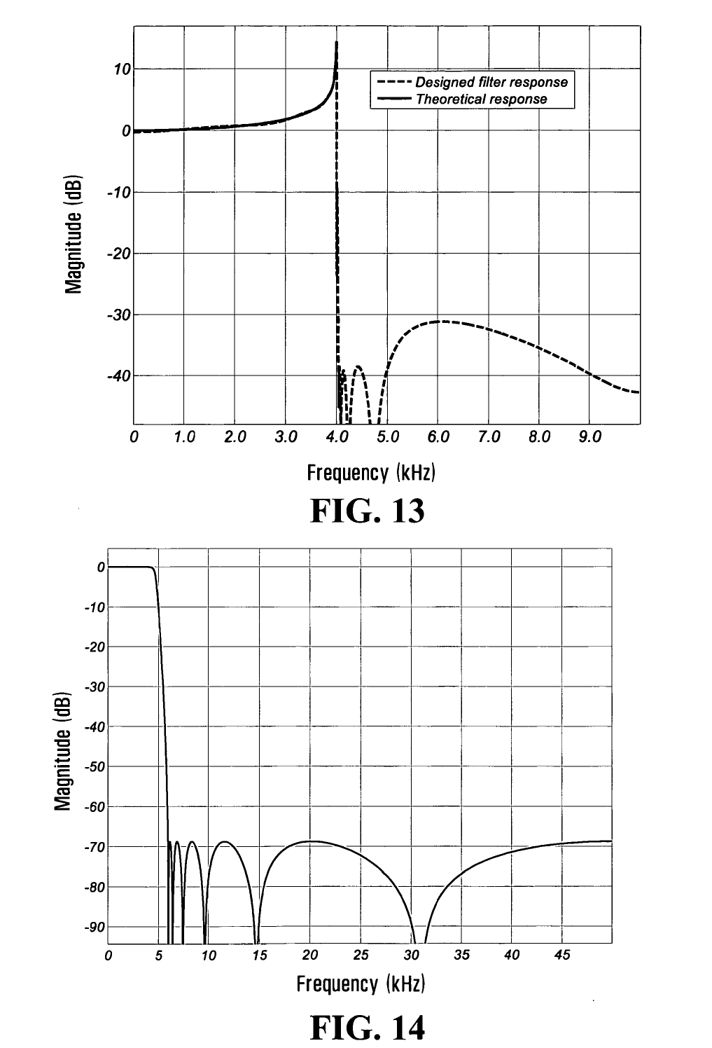

To find optimal filters to meet the desired characteristics, a genetic search algorithm [28], for example, can be employed. Weights computed by a software function and the low-pass filter parameters were used as the search variables in one embodiment. FIG. 13 shows the frequency response of the resulting shaping filter with K=6 second-order sections. As this figure shows, the shaping filter provides a frequency response that closely matches the desired response over the passband and up to frequencies just inside the stopband. However, at higher frequencies in the stopband the attenuation is somewhat small.

FIG. 14 shows that the first-stage ILPF provides at least 70 dB attenuation over frequencies where the shaping filter might not provide adequate attenuation. Therefore, the ILPF not only attenuates the out-of-band signals, it can also help the shaping filter to provide more accurate samples.

A second-stage ILPF can be designed using a similar technique. This allows the second-stage ILPF to further increase the attenuation over the stopband where the shaping filter and the first-stage ILPF might not provide enough attenuation. Since the second-stage ILPF may run at a higher frequency, minimizing the filter order may significantly decrease processing time.

Also, to maintain accuracy, the fixed-point format of intermediate signals may be chosen based on numerical analysis that determines the impact of different precisions on the statistical properties of generated fading variates.

As shown in FIG. 8, a fading channel simulator may include two GVGs, for real and imaginary components, K cascaded biquads and 2K multipliers to implement the shaping filter, and P cascaded biquads and 2P multipliers to implement the ILPFs. An example biquad datapath has also been described above, and is shown in FIG. 9.

A time-multiplexed resource sharing approach as described above can be used to improve performance of an SSF and multi-stage interpolation. In this technique, the SSF is time-shared with the initial stages of ILPFs. The throughput of a fading simulator depends on the binding of second-order sections to the shared resources. The sampling rate of hardware-based digital filters on conventional FPGAs can be high enough that the throughput reduction of a time-multiplexed scheme, compared to a direct instantiation approach, does not impact the maximum target sampling rate.

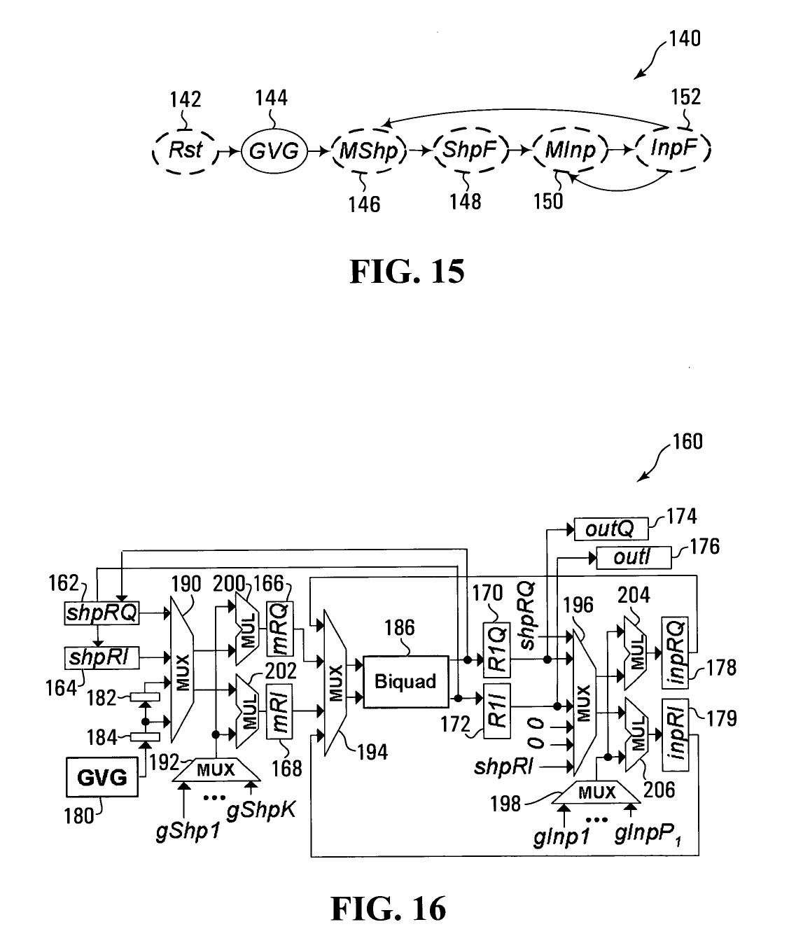

In one embodiment, due to the relatively slow rate of SSF and initial stages of ILPFs, the shaping filter and the first ILPF are implemented using one shared biquad. The second ILPF is mapped to a separate set of configurable resources, on an FPGA, for example, to achieve the target sampling rate. FIG. 15 shows a control flow-graph that can generate an appropriate control sequence for the datapath shown in FIG. 16. The example control flow graph 140 includes states 142 through 152. The example datapath 160 includes registers 162, 164, 166, 168, 170, 172, 174, 176, 178, 179, a GVG 180, delay registers 182, 184, a biquad 186, multiplexers 190, 192, 194, 196, 198, and multipliers 200, 202, 204, 206, interconnected as shown. This datapath illustrates another example of a time-multiplexed circuit that enables the biquad 186 to be shared for multiple filtering operations in a series of cascaded filtering operations.

A state machine controller implementing the control flow 140 starts in reset state “Rst” 142, where “gShp1” to “gShpk”, which may be stored in further registers (not shown) in some embodiments, are initialized with K scaling factors of the spectral shaping filter, and “gInp1” to “gInpP”, which may similarly be stored in further registers (not shown) in some embodiments, are initialized with P₁ scaling factors of the first ILPF. Intermediate registers, such as “shpR1” and “shpRQ” 164, 162, are cleared to zero. In the next state, “GVG” 144, two Gaussian variates are generated per clock cycle. State “MShp” 146 denotes a multiplier state of the shaping filter and state “MInp” 150 denotes a multiplier state of the first-stage interpolator. At the “ShpF” (“InpF”) state 148 (152), one of the K (P₁) sections of the shaping filter (first-stage ILPF) is executed. For every execution of the “ShpF” state 148, states “MInp” 150 and “InpF” 152 will be executed I₁ times, to perform an interpolation or upsampling operation. After K executions of state “ShpF” 148 (and thus KI₁ executions of the “MInp” and “InpF” states 150, 152), “InpF” 152 goes back to state “MShp” 146 to multiply the previously generated Gaussian variates with one of the shaping filter scaling factors. In some embodiments, a downsampling operation may be implemented instead of an upsampling operation.

Due to the slower operating rate of the shaping filter compared to the interpolator, only one GVG core 180 might be used to generate both I and Q samples. The registers of the datapath and the K+P₁ scaling factors can be implemented using configurable slices while 4(K+P₁) registers (note that each biquad has four intermediate delay registers) and 4(K+P₁) coefficients of K+P₁ SOSs can be implemented using dual-port memory blocks. The datapath in FIG. 16 utilizes 3% of configurable slices, 1% of dedicated multipliers, and 6 on-chip memory blocks of an FPGA in one implementation. The second ILPF may be designed using a fourth-order low-pass inverse-Chebyshev IIR filter, for example, and implemented using one shared biquad, which receives as its inputs either the outputs of the first ILPF (i.e., from the “outI” and “outQ” registers 176, 174) or “0” values inserted for zero padding. One example implementation of a complete fading channel simulator utilizes 4% of configurable slices, 20% of dedicated 18×18-bit multipliers, and 10 memory blocks, and operates at 50 MHz.

An important property of this proposed scheme is that the complexity of the filter implementation only impacts the rate of fading variate generation rate and has almost no effect on hardware resource utilization. For example, even though the shaping filter and the ILPF might be designed to emulate mobile channels sampled at 10 MHz, the fading channel simulator could be running at a high clock frequency, such as 50 MHz. In this case, the simulator operates 1.25 times faster than the target sample rate. The simulator can, however, be slowed down to emulate a wide variety of different channel characteristics over bandwidths of up to 12.5 MHz. To further speed up the fading sample generation rate, commutative properties of computing the cascaded SOSs can be exploited so as to re-order the operations in such a way that the multiplication state “MShp” 146 (“MInp” 150) can be performed simultaneously with the “ShpF” 148 (InpF” 152) state.

Denoting Rᵢ as the output register of the i-th multiplier and BRᵢ as the register at the output of the i-th biquad in the cascade structure of FIG. 16, Table I below shows an out-of-order scheduling scheme that can reduce the required number of clock cycles to execute N cascaded second-order sections from 2N in the sequential scheme down to N.

TABLE I
Out-Of-Order Execution Scheme For Cascade Structure

| Clock No. | State | Operations |
|---|---|---|
| 6i + 0 | 1 | R₄ = MUL(g₄, BR₃); |
| | | BR₁ = Biq(sos₁, R₁); |
| 6i + 1 | 4 | R₃ = MUL(g₃, BR₂); |
| | | BR₄ = Biq(sos₄, R₄); |
| 6i + 2 | 3 | R₆ = MUL(g₆, BR₅); |
| | | BR₃ = Biq(sos₃, R₃); |
| 6i + 3 | 6 | R₅ = MUL(g₅, BR₄); |
| | | BR₆ = Biq(sos₆, R₆); |
| 6i + 4 | 5 | R₂ = MUL(g₂, BR₁); |
| | | BR₅ = Biq(sos₅, R₅); |
| 6i + 5 | 2 | R₁ = MUL(g₁, BR₀); |
| | | BR₂ = Biq(sos₂, R₂); |

A clock frequency of 20 MHz generates 10 Msamples/sec. When the fading channel simulator operates at 50 MHz, this approach provides 2.5 times speed up to generate fading variates up to 25 Msamples/sec. Increasing the sample generation throughput in this way uses N=K+P₁+P₂ times the number of registers compared to the sequential approach, as given in Table I. An important point to note from Table I is that allocating a physical register for every instance can lead to an inefficient register allocation while a register can be re-used after its lifetime (when its value is no longer needed). Consider the fact that Rᵢ can be re-used after Biqᵢ reads its content, and BRᵢ can be re-used after multiplication by g₁₊₁ where gᵢ₊₁ is the scaling factor of the Biqᵢ₊₁. The scheduling of operations after re-using the registers is given in Table II where only one register is utilized for the output of multiplier operations.

TABLE II
Out-Of-Order Scheduling and Register Renaming of Cascade
Structure

| Clock No. | State | Operations |
|---|---|---|
| 6i + 0 | 1 | R = MUL(g₄, BR₃); |
| | | BR₁ = Biq(sos₁, R); |
| 6i + 1 | 4 | R = MUL(g₃, BR₂); |
| | | BR₄ = Biq(sos₄, R); |
| 6i + 2 | 3 | R = MUL(g₆, BR₅); |
| | | BR₃ = Biq(sos₃, R); |
| 6i + 3 | 6 | R = MUL(g₅, BR₄); |
| | | BR₆ = Biq(sos₆, R); |
| 6i + 4 | 5 | R = MUL(g₂, BR₁); |
| | | BR₅ = Biq(sos₅, R); |
| 6i + 5 | 2 | R = MUL(g₁, BR₀); |
| | | BR₂ = Biq(sos₂, R); |

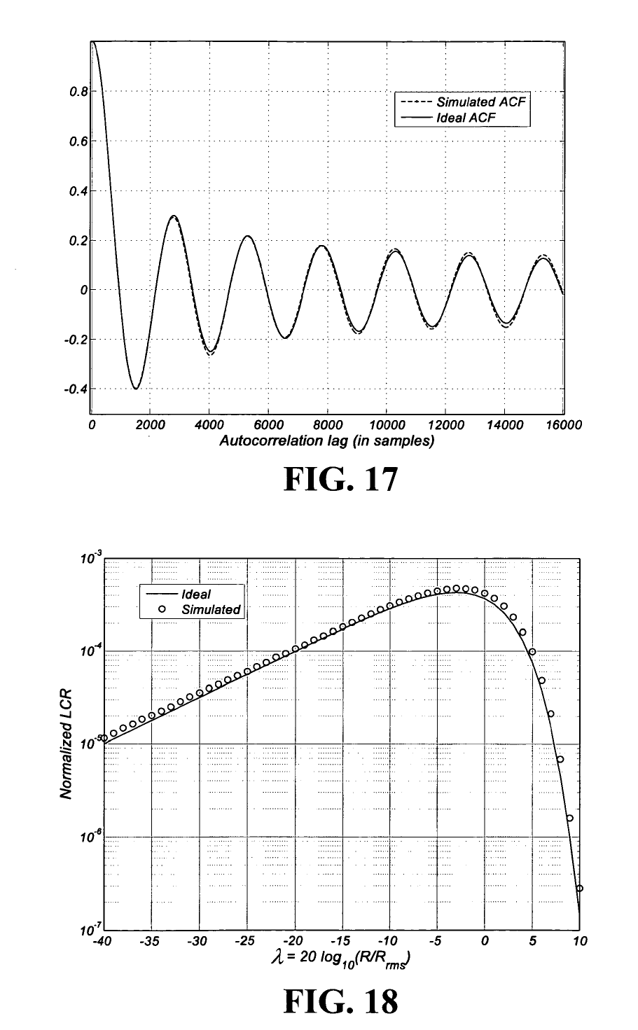

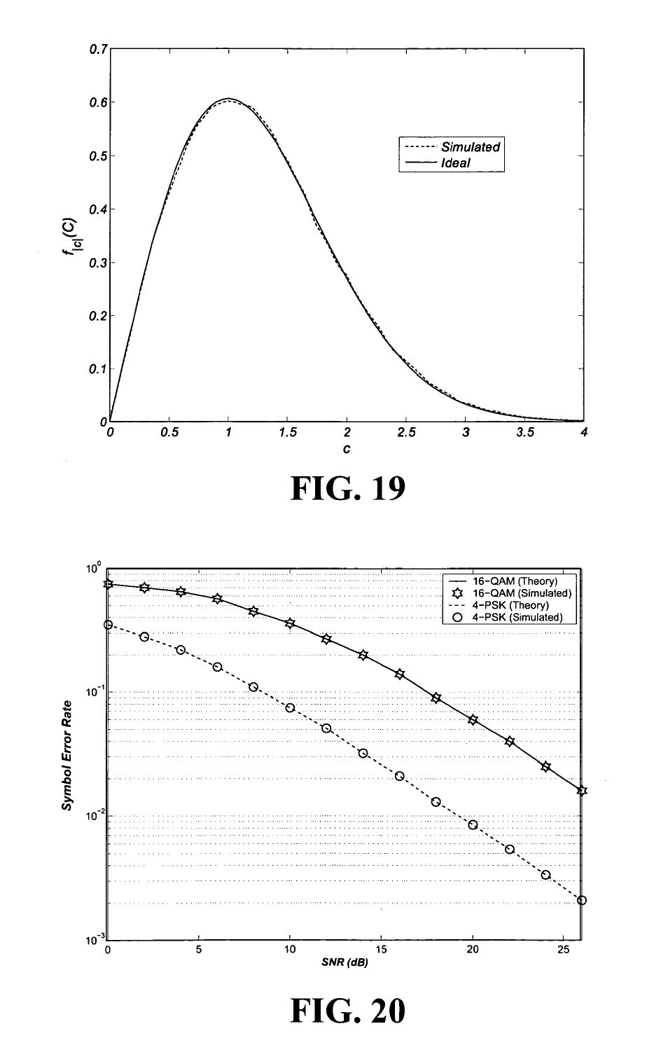

A Hardware description language (HDL) model of the datapath of FIG. 16 was simulated to verify the accuracy of the results against the fixed-point software simulation results. A block of 50,000 Gaussian variate samples was generated and passed through the above example filters, then the statistical properties of the 2.5×10⁷ generated fading variates were measured. FIG. 17 plots the desired ACF along with the ACF of the samples generated with the new model. As FIG. 17 shows, the generated ACF accurately matches the theoretical ACF. The LCR [13] of the envelope of the generated fading variates and the desired LCR are plotted in FIG. 18. Here again a close match is observed. Finally, FIG. 19 plots the pdf of the generated fading variates against the ideal pdf. These plots show that a fading channel simulator according to an embodiment of the invention can faithfully reproduce the statistical properties of a reference model.

A communication system with 4-PSK and 16-QAM modulations and zero-forcing equalization at a receiver was also simulated to show the performance of the new fading simulator with fixed point arithmetic in FIG. 20. Here, for each signal to noise ratio (SNR), 10¹⁰ symbols were transmitted and the average symbol error rate (SER) was measured.

According to another embodiment, transformation-based filter designs are used to provide spectral shaping for a rational implementation.

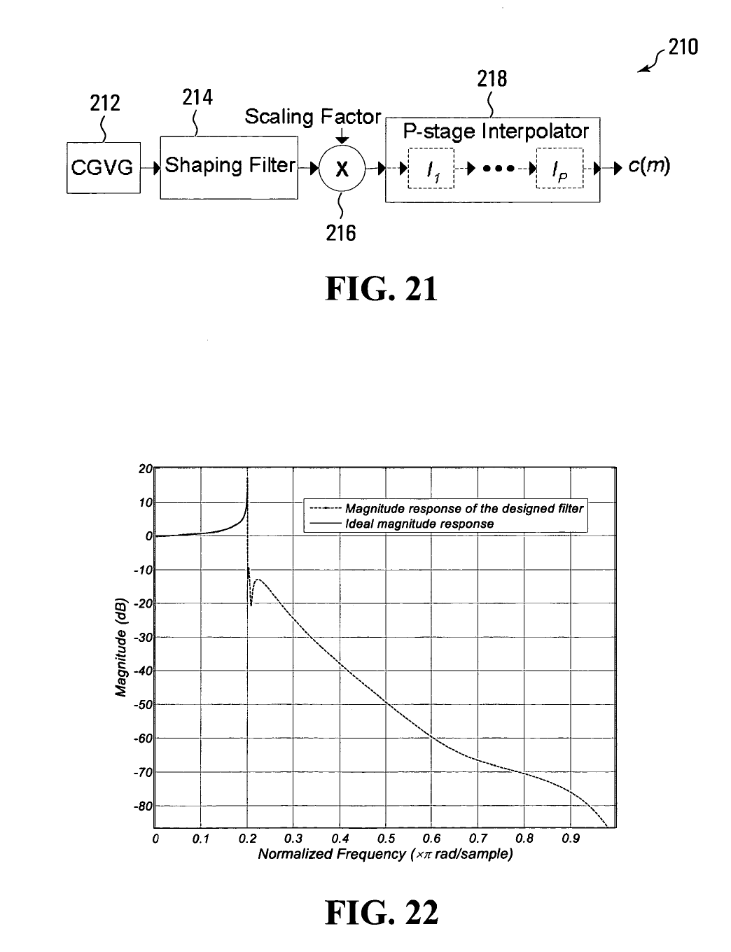

As shown in FIG. 21, in an example filter-based fading channel simulator 210, the generated samples from a complex GVG (CGVG) 212 are passed through a shaping filter 214 and multiplied in a multiplier 216 by a scaling factor to normalize the power of the final resulting channel variate c(m). Then the sampling rate of generated fading variates is increased using a P-stage interpolator 218.

To implement the Jakes' PSD, this embodiment uses as the shaping filter 214 an IIR elliptic filter that has the sharpest transition from the passband to the stopband among different classical IIR filters for a given order [25]. An elliptic filter designed using the cascade of Direct-Form II second-order sections (biquads) is more robust under quantization than the Direct-Form structure [25]. A typical assumption that the Doppler spectrum for mobile speeds of interest is less than 2 KHz wide was also used. In one embodiment, 10 samples/period of the highest frequency of an analog signal were used, so F_{ch}=10f_{D}=20K samples/sec. For a fixed maximum discrete Doppler rate f_{D}Tₛ=0.1, K=5 cascaded biquads were used to realize the Jakes' PSD.

As shown in FIG. 22, the magnitude response of the resulting elliptic shaping filter matches closely with the ideal response in the passband and has a sharp cutoff. An important point to note in FIG. 22 is that if the stopband attenuation of the shaping filter is not large enough, then the out-of-band noise passed through the filter may impact the accuracy of the statistics of the generated fading variates. Designing a narrowband filter with sharp cutoff and large attenuation leads to a high-order filter. Thus, to obtain the closest approximation to the desired frequency response with a relatively small filter order, the approximation error can be minimized in the passband of the spectral shaping filter. The low-pass filters utilized in the interpolation stages at 218 can be designed with extra attenuation over the transition region and the stopband.

In order to design a P-stage interpolator, the assumption was made that the WSS channel model can be used for the urban mobile radio channel having bandwidths of up to 10 MHz [22], [30]. The interpolation factor of this example system therefore can be up to I=[Fₛ/F_{ch}]=500.

As an alternative, smaller-degree low-pass IIR filters that provide almost linear phase response in the passband may be used as ILPFs. In one embodiment, a two-stage interpolator uses two low-pass Chebyshev Type II IIR filters, one for I₁=5 and one for I₂=100. The ILPFs have a maximum of 0.01 dB attenuation in the passband and a minimum of 100 dB attenuation in the stopband in one embodiment.

To implement the fading channel simulator with fixed-point arithmetic, the stability of the designed IIR filters after quantization was ensured by keeping all poles within the unit circle on the z-plane. Also, to ensure computational accuracy, the fixed-point format of intermediate signals was chosen based on numerical analysis with different precisions.

Rather than implementing different instances of second-order sections, a time-multiplexed resource sharing scheme can again be used to achieve the maximum performance with a minimum amount of FPGA resources, leading to an efficient hardware-based implementation of a fading channel simulator. In this technique, resource sharing of independent operations of the shaping filter and the ILPFs can offer significant resource reduction in the implementation of the fading simulator.

For example, it is possible to bind the operation of the shaping filter and the first ILPF to be performed by only one shared biquad. The second ILPF can use a separate set of configurable resources to achieve the target throughput.

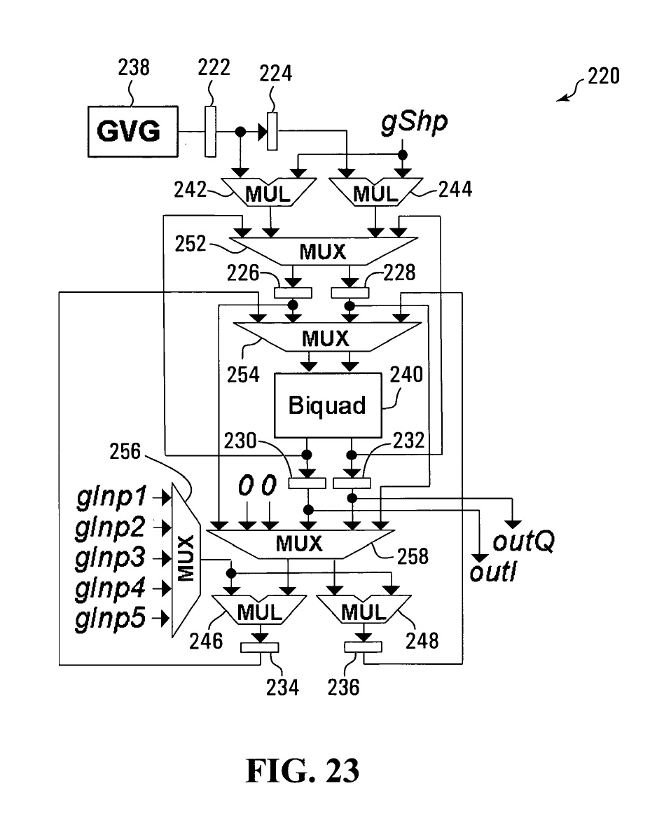

FIG. 23 shows one example of an SSF and the first stage ILPF datapath. The control flow graph of FIG. 15 may be used with a shaping filter and a first Chebyshev Type II low-pass filter having a datapath as shown in FIG. 23. The example datapath 220 includes registers 222, 224, 226, 228, 230, 232, 234, 236, a GVG 238, a biquad 240, multipliers 242, 244, 246, 248, and multiplexers 252, 254, 256, 258, and is similar to the datapath 160 of FIG. 16. The operation of the datapaths 160, 220 are also similar. The datapath 220 includes another example of an interconnection circuit that enables time-multiplexed sharing of the biquad 240.

The second-stage ILPF cascaded after the SSF and first-stage ILPF datapath of FIG. 23 can be implemented, for example, using two biquads which receive as their inputs either the outputs of the first ILPF or “0” values inserted for zero-padding.

The filter coefficients and the biquad registers may be stored in on-chip memory blocks, as described above. The complete fading channel simulator in this example utilizes 4% of slices, 19% of dedicated multipliers, and 2% of memory blocks in one FPGA implementation.

As above, the complexity of the filter implementation impacts only the fading variate generation rate and has almost no effect on the hardware resource utilization, whereas in the direct instantiation of biquads, the resource utilization becomes critical as filter order increases.

As noted above, in the design of the SSF, since no constraints are imposed on the phase response, IIR filters, which are typically much smaller than their FIR counterparts, can be used. In one embodiment, the desired magnitude response of the l-th SSF is approximated with an IIR filter of order 2N_{Q}. The magnitude response of the SSF is

$${H}_{l} ( {e}^{jω} ) = {\prod }_{q = 1}^{{N}_{Q}} \{ {g}_{l , q} \times \frac{1 + {b}_{1 , l , q} {e}^{- jω} + {b}_{2 , l , q} {e}^{- 2 jω}}{1 + {a}_{1 , l , q} {e}^{- jω} + {a}_{2 , l , q} {e}^{- 2 jω}} \} \qquad ( 19 )$$

which is equivalent to the magnitude response of N_{Q} cascaded second-order canonic sections (biquads). In (19), b_{1,l,q}, b_{2,l,q}, a_{1,l,q} and a_{2,l,q} denote the real-valued coefficients and g_{l,q} denotes the scaling factor of the q-th biquad of the l-th SSF.

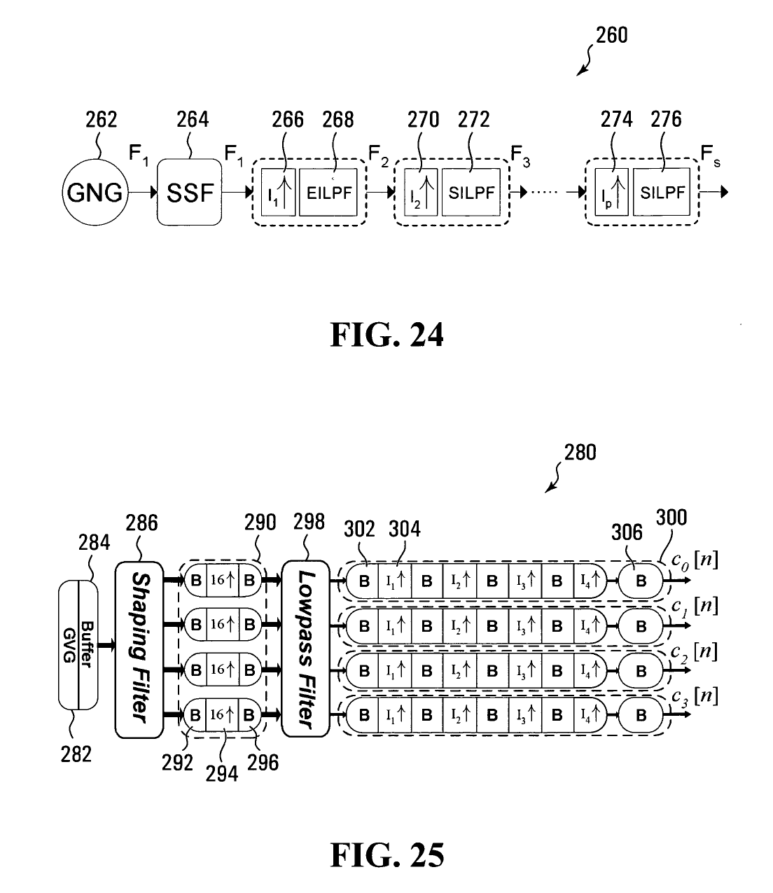

FIG. 24 is a block diagram of an example fading simulator 260 in which an embodiment of the invention may be implemented. The simulator 260 includes a Gaussian Noise Generator (GNG) 262, an SSF 264 operatively coupled to the GNG, and a series of upsampling stages. The upsampling stages include interpolation filters 268, 272, 276. For clarity, upsampling factors for the filters 268, 272, 276 are shown in FIG. 24 at 266, 270, 274. It should be appreciated, however, that upsampling and filtering need not be provided in separate physical elements. FIG. 24 shows an embodiment in which upsampling is performed using interpolation filters.

The GNG 262 may be implemented, for example, using 12 uniformly distributed random variables uᵢδ[−0.5,0.5). Since the fading samples are strongly correlated, generating the uniform samples with a simple linear feedback shift register (LFSR) structure does not change the correlation properties significantly. Also, from the central limit theorem, filtering the input process with the SSF and the EILPF will help to improve the Gaussian distribution of the fading samples. Other Gaussian variate generators may instead be used where greater accuracy is desired [26].

Example implementations of the SSF 264 and the filters 268, 272, 276 are described in further detail below.

Gaussian samples are generated in the GNG 262 at F₁ samples per second and sent to the SSF 264. The output of the SSF 264 is then up-sampled I₁ times at 266 in the elliptic interpolation lowpass filter (EILPF) 268, which generates F₂=I₁×F₁ samples per second. Next the samples are further up-sampled and interpolated several times using fading-specific interpolation lowpass filters (SILPFs) 272, 276 to obtain the desired output sample rate Fₛ.

Without loss of generality, we consider filter design for the random scattering component of the n-th path assuming the maximum Doppler frequency f_{D}=f_{Dn}. An example SSF is designed at a sampling frequency F₁, where 4f_{D}<F₁<8f_{D}. Choosing F₁ in this fashion satisfies the minimum Nyquist rate while keeping the computational complexity low. In addition, this provides the opportunity to exploit power-of-2 interpolation factors to further reduce hardware complexity and simplify filter design.

Given a desired frequency response S_{c}^{1/2}(f)=(π²(f_{d}²−f²))^{-1/4}, |f|<f_{D}, the filter coefficients can be found. Optimal values might be calculated, for example, by minimizing the p-norm. After the initial filter design, the filter can be tested with fixed-point variables, and scaling factors g_{l,q} can be determined to sufficiently limit the magnitude of the generated samples to keep them within a representable range.

The generated samples from the SSF 264 are upsampled at 266 I₁=16 times in one embodiment by the EILPF 268. The samples are passed through T_{g} successive SILPFs, two of which are shown in the example simulator 260. The i-th SILPF interpolates the signal 2^{k}^{ᵢ} times. Based on the example processing architecture, the relation between F₁ and the target output sampling rate Fₛ is

$${F}_{s} = 16 \times {F}_{1} \times {\prod }_{i = 1}^{{T}_{g}} {2}^{{k}_{i}} .$$

Thus, F₁=2^{-(4+s}^{_{g}}⁾Fₛ, where

$${S}_{g} = {\sum }_{i = 1}^{{T}_{g}} {k}_{i}$$

is an integer value within the range log₂(Fₛ/f_{D})−7≦S_{g}<log₂(Fₛ/f_{D})−6. Based on a maximum interpolation factor 2^{K}^{ₘₐₓ}, where Kₘₐₓ=4+max{S_{g}}, each SILPF 272, 276 is assigned a specific interpolation factor. The minimum Doppler frequency that can be simulated by this system can be shown to be

f_{D}^{min}=2^{-(T}^{_{g}}^{K}^{ₘₐₓ}⁺⁷⁾Fₛ. (20)

In a biquad implementation, the maximum Doppler frequency may be dictated by the biquad processor that performs the SSF operations. If the biquad processor requires C_{bq} clock cycles to perform the biquad operations, it can be verified that the maximum Doppler frequency is

$${f}_{D}^{max} = 0.5 \times {f}_{CLK} \times {( {C}_{bq} {\sum }_{l = 1}^{{N}_{f}} {N}_{B} ( l ) )}^{- 1} , \qquad ( 21 )$$

where f_{CLK} is the biquad processor clock frequency, N_{f} is the number of filters, and N_{B}(l) denotes the number of biquads in the l-th filter.

A generated stream of Gaussian samples is interpolated to reach to the target output sample rate Fₛ. Let P denote the integer upsampling factor. Interpolation of the signal {x[n]} is performed by inserting P−1 zeros between each two successive samples of {x[n]} and then passing the resulting stream through a lowpass filter with cut-off frequency π/P radian/sec. Although lowpass filtering is often done using conventional FIR or IIR filters, it may be more efficient if the interpolation filters were realized with multiplication-free filters (see [32] for example).

For application to fading simulation, when f_{D}/Fᵢ<<1, where is the sample rate at the i-th stage, a multiplication-free filter with the frequency response in (8) may be used. This is equivalent to the frequency response of a cascade of l_{z} multiplication-free filters

$${d}_{P}^{l} = [ \underbrace{{P}^{- 1} , {P}^{- 1} , … , {P}^{- 1}}_{P elements} ] . \qquad ( 22 )$$

The frequency response of such a filter is shown and FIG. 1, for P=5 and different values for l_{z}.

FIG. 25 is a block diagram of a fading simulator 280 according to an embodiment of the invention. In the simulator 280, a GVG 282 is operatively coupled to a shaping filter 286 through a buffer 284. A first upsampling stage 290 is operatively coupled to the shaping filter 286 and includes input and output buffers 292, 296 and an upsampler 294 in each of four independent paths. The lowpass filter 298 is a first-stage EILPF in some embodiments, and is operatively coupled to the first upsampling stage 290. Subsequent upsampling stages 300 are shown for each of the four independent paths. In order to avoid overly complicating the drawing, only buffers 302 and upsampling stages 304 have been explicitly shown. It should be appreciated, however, that the stages 300 may be implemented using SILPFs, for example. A terminal buffer 306 is also provided in each path in the example shown.

The simulator 280 can generate Nₚ=N_{f}=4 independent fading processes that can be configured with different path gains. The multiple paths can be used to model, for example, frequency-selective channels or fading channels in MIMO systems. The generated Gaussian samples from the GVG 282 are buffered at 284 and passed to the first shared filter processor 286, which runs the designed SSF from (19) in one embodiment, in four parallel and independent threads. Each thread of data is buffered at 292, upsampled 16 times at 294, buffered at 296, and passed through an EILPF at 298 that can be implemented using the same or another shared filter processor. Each stream of data is then passed to a subsequent interpolation filter (IF). Each IF includes four configurable SILPFs, represented at 304, that are interconnected with buffers 302, which are elastic buffers in one embodiment. Each IF also contains a terminal buffer 306, which may also be an elastic buffer, for interfacing to external hardware.

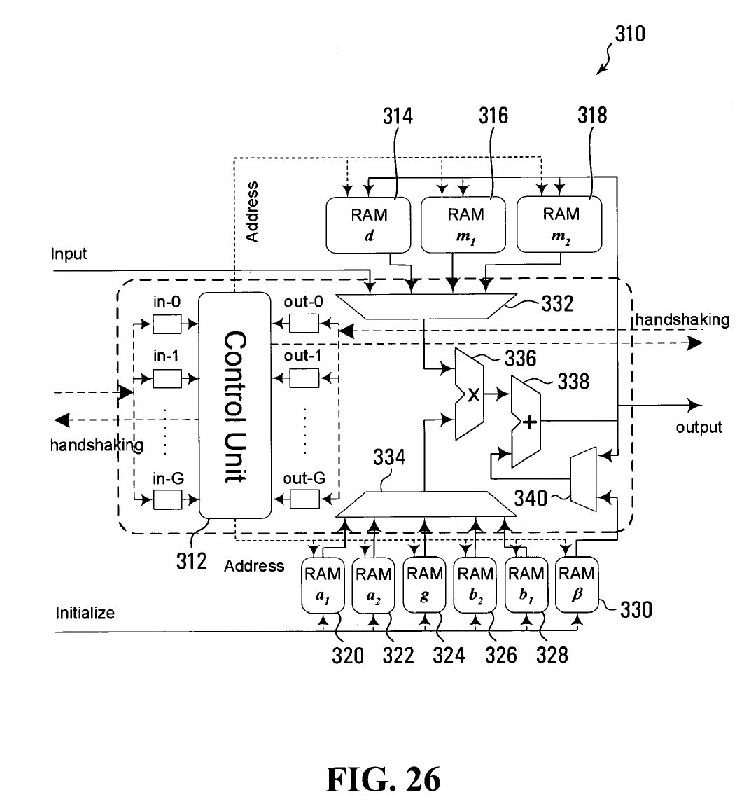

A fixed-point processor is used to perform the operations of the SSF and the EILPF in some embodiments. FIG. 26 is a block diagram of the architecture of an example biquad processor 310. The processor 310 includes a control unit 312, memory elements 314, 316, 318, 320, 322, 324, 326, 328, 330, shown as RAM storage which may be implemented in one or more RAM devices, multiplexers 332, 334, 340, a multiplier 336, and an adder 338. The control unit 312 is operatively coupled to the memory elements 314, 316, 318, 320, 322, 324, 326, 328, 330, as shown, and is also operatively coupled to the multiplexers 332, 334, 340 to control their operation. Connections between the control unit 312 and the multiplexers 332, 334, 340 have not been shown in FIG. 26 so as to avoid overly complicating the drawing.

The main datapath element in the processor 310 is a multiplier-accumulator (MAC), including the multiplier 336 and the adder 338. The multiplier 336 multiplies in-phase and quadrature data components by coefficients, and the adder 338 accumulates the resultant products.

The output of the biquad processor 310, provided by the adder 338, is written into RAM d 314, which holds intermediate results. The RAM m₁ 316 and the RAM m₂ 318 store the complex contents of the biquad memories. The biquad coefficients are stored in RAM a₁ 320, RAM a₂ 322, RAM b₁ 328, RAM b₂ 326, and RAM g 324. The biquad processor 310 can also add a bias value from RAM β 330, in the case of simulating Rician fading.

The control sequence for running cascaded biquads is generally quite straightforward. As described above, multiple stages of a cascade could potentially use the same biquad. Data output by a biquad may be returned to its inputs, through the multiplexer 332, which is another example of an interconnecting circuit that enables one biquad to be used in implementing a cascade.

When simulating multiple paths, where each path could have different filter specifications and different sample rates, flexible implementation of the control unit 312 may be more challenging. In addition, a fading simulator might generate samples for more than one external system with different clocks. To improve the robustness of the biquad processor 310 in a multi-path or multiple thread implementation, one or more flags, two in the example shown in FIG. 26, are assigned to each thread of cascaded biquads (i.e., for each individual path labeled in-i and out-j in FIG. 26). These flags are an example of handshaking information that may be exchanged to coordinate operation of the elements in a channel simulator or emulator, and govern the data flow through each thread. For example, for the i-th thread or path, in-i could be driven high by the control unit of a preceding biquad processor when its output data is ready to be read as input data by the next biquad processor, and out-i could be driven high by the control unit of a next biquad processor when output data from a preceding biquad processor can be written to the next processor. For each thread, a biquad processor may execute biquads unless either of the input or output flags is de-asserted. To prevent overwriting of the unprocessed data, biquads in each thread could be scheduled to be executed from the last biquad to the first. The control unit 312 of the biquad processor 310 controls data flow into and out of the biquad processor in accordance with the flags, as well as internal operations of the biquad processor itself.

It should be noted that flag-based control may be useful, for example, between different filters. According to embodiments of the invention, a filter may include multiple cascaded operations, which can be implemented using one biquad. The biquad processor 310 also supports another type of biquad re-use, between different threads or paths in a multi-path implementation. Flags may or may not be used for controlling data flow within one filter. In some embodiments, a biquad-implemented filter is one of a series of filters in a multi-stage interpolator. The flags may be used to control data flow between those filters.

The biquad processor 310 represents one example of a signal filtering apparatus including an element that has an input and an output and is operable to perform any of multiple signal filtering operations on a signal received at the input. The signal filtering operations are associated with respective sets of filter parameters stored at 320, 322, 324, 326, 328, 330. A controller, in the form of the control unit 312, is operatively coupled to the element and is operable to control selection of the respective sets of filter parameters for use by the element. In one embodiment, the control unit 312 controls selection of the respective sets of filter parameters by controlling addresses in the RAMs 320, 322, 324, 326, 328, 330 from which filter parameters are provided to the element. This enables the element to be used to implement the signal filtering operations in respective parallel filtering paths, such as shown in FIG. 25.

As will be apparent from the foregoing, the signal filtering operations and the respective sets of filter parameters, and thus the parallel filtering paths, may correspond to respective communication signal propagation paths.

A series of biquad processors may be provided in a multi-stage filtering path. As shown in FIG. 25, biquad processors may be operatively coupled together through elastic buffers. Data flow between stages may be controlled on the basis of handshaking information, illustratively flags, exchanged between adjacent control units.

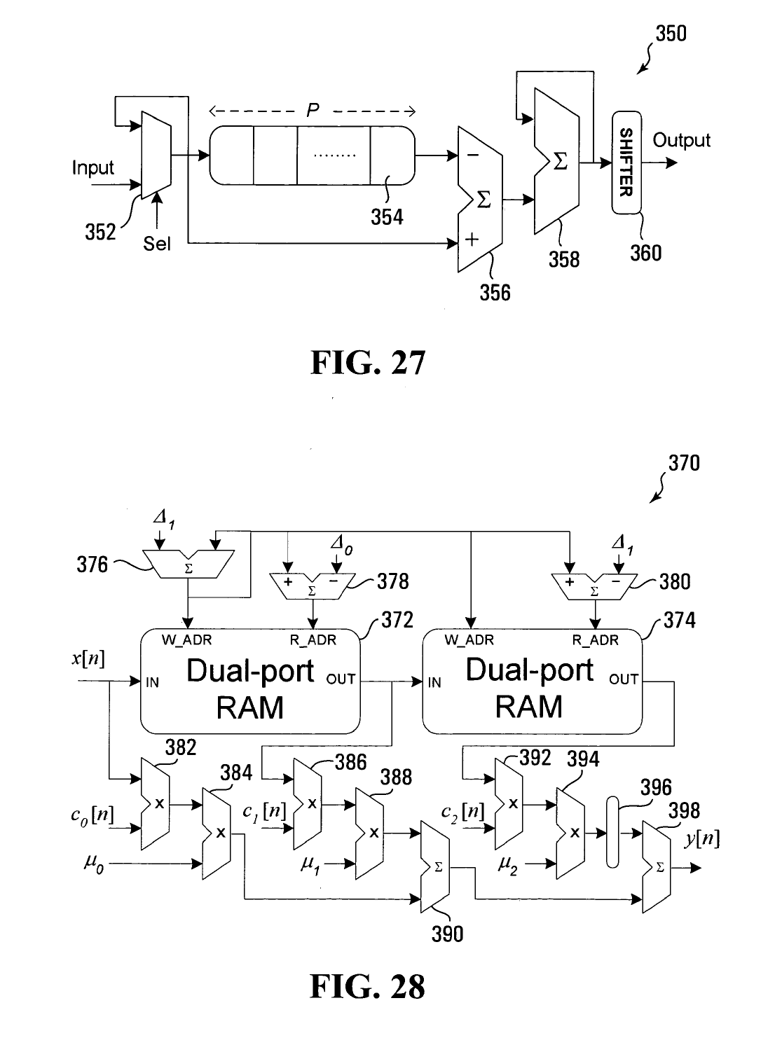

FIG. 27 is a block diagram of an example SILPF 350, which includes a multiplexer 352, a P-stage first-in first-out (FIFO) register 354, adders 356, 358, and a shifter 360. This structure is a parametric interpolator that uses the multiplication-free filter Dₚ²(e^{-jω}). With this datapath, the input signal can be upsampled and interpolation filtering can also be performed. The interpolation factor P is passed to this circuit as a parameter to specify the length of the FIFO 354. After interpolation, the signal amplitude can be multiplied by 2^{-k} (shifted to the right) at 360, where k is another input parameter passed to this circuit. This multiplication can be used to adjust the signal power. In the example circuit 350, a new sample is read once every P cycles.

Considering a filter having the frequency response in (8) as an example, the filter impulse response is triangular:

h_{P,k}=2^{-k}×[1, 2, . . . , P−1, P, P−1, . . . . , 2, 1]. (23)

For the special case of P=2^{k/2}, h₂_{^{k/2}}_{,k}[n]=dₚ²=dₚ¹*dₚ¹ where * denotes the convolution operation. When designing the filters and sample rates, setting P=2^{k} helps reduce system complexity by eliminating the need for extra multiplications that adjust the signal amplitude.

In the example simulator 280 (FIG. 25), consecutive blocks are interconnected with elastic buffers. Those buffers operate in two modes in some embodiments. When operating in a handshaking mode, the receiver block requests to read date samples prior to reading from the buffer. When the buffer is empty, the receiver is informed to stop requesting until a new data word arrives. Likewise, the transmitter requests to write into the elastic buffer and is informed when the buffer is full. This transfer mechanism may be controlled by the in-i and out-i flags described above, for instance.

If an output signal x(t) is sampled out at Fₛ′ samples per second, it can be approximated as the sampled signal x′(t)≈x(ηt), where η=Fₛ′/Fₛ. The ACF of x′(t) is R_{x′(τ)}=Jₒ(2π(ηf_{D})τ). Using five elastic buffers in addition to T_{g}=4 SILPFs in each IF, for example, enables a minimum Doppler frequency f_{D}≧2⁻²²Fₛ to be simulated.

FIG. 28 is a block diagram of an example tapped delay generator for three-path fading. The delay generator 370 includes two buffers, implemented using dual-port RAM devices 372, 374 in the example shown, address adders 376, 378, 380, multipliers 382, 384, 386, 388, 392, 394, and adders 390, 398. The register 396 is provided for timing purposes, to adjust for different propagation times through different parts of the circuit.

The data signal x[n] is stored in a buffer of length Δ₀ in the dual-port RAM 372. The output of the first buffer is passed to the second buffer of length Δ₁ in the dual-port RAM 374. In other embodiments where fading on more than three paths is being simulated, additional buffers are provided. In the delay generator 370, Δ₀ represents the relative delay of the second path compared to the first path, and Δ₁ is the relative delay of the third path compared to the second path. The delayed copies of the input signal are multiplied at 382, 386, 392 by generated fading samples cᵢ[n], weighted at 384, 388, 394 by scaling factors μᵢ[n] representing the power-delay profile, and then added together at 390, 398 to simulate the multipath fading.

It should be apparent that the fading samples cᵢ[n] may be generated using a three-path version of the simulator 280 of FIG. 25, for example.

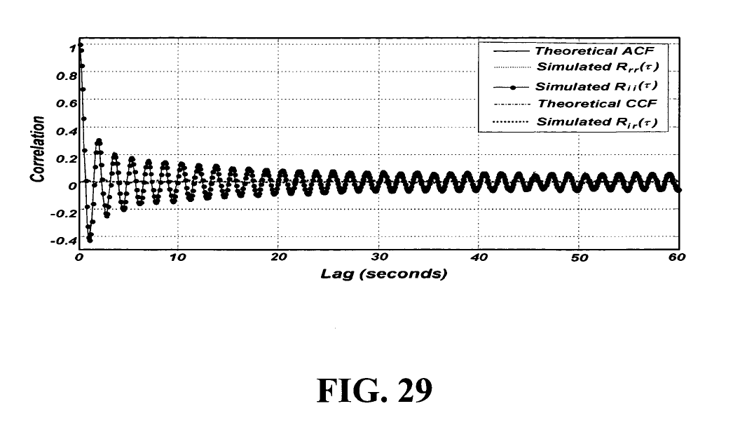

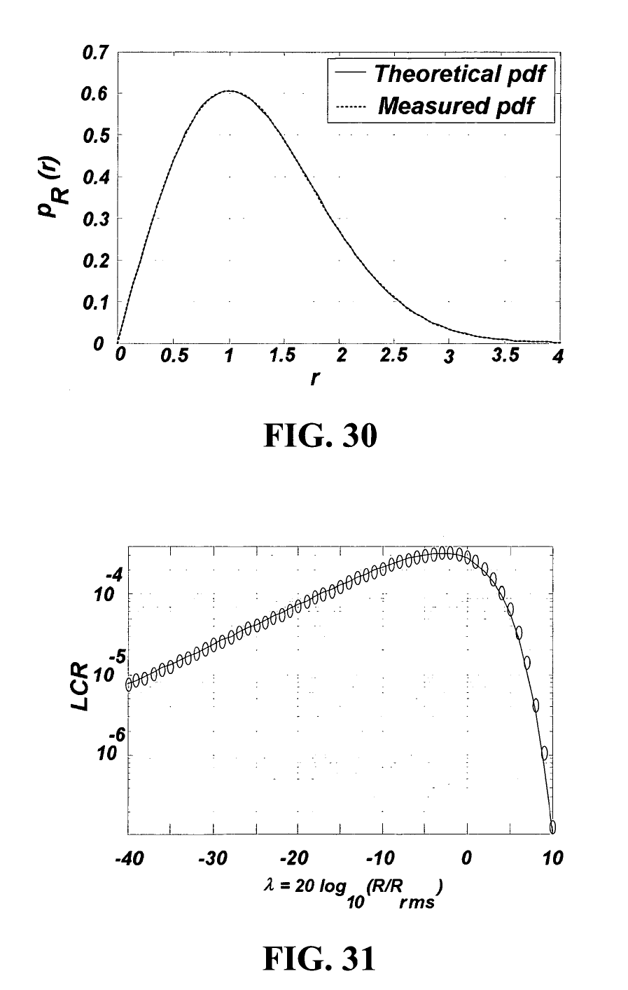

FIGS. 29 to 31 show various performance plots for a four-path fading simulator based on components illustrated in FIGS. 25 to 28, for a Doppler frequency f_{D}=0.6 Hz generating Fₛ=2.5 million samples per second per channel. FIG. 29 shows the autocorrelation and crosscorrelation between real and imaginary parts of a generated fading process, and shows a close match between the ideal response and generated results up to 60 seconds. The probability density function (pdf) for the amplitude of generated samples is shown in FIG. 30. The measured pdf accurately mimics the Rayleigh pdf. The LCR of the generated fading samples in FIG. 31 shows a good match between theory and generated results.

What has been described is merely illustrative of the application of principles of embodiments of the invention. Other arrangements and methods can be implemented by those skilled in the art without departing from the scope of the present invention.

For example, the contents of the drawings are shown solely for illustrative purposes. Embodiments of the invention may be implemented using further, fewer, or different components, with similar or different interconnections, than specifically shown. Multiple implementations of filter components, in hardware, software, firmware, and/or combinations thereof, are also contemplated.

The various plots, the example microinstruction format, and the example control flow-graph shown in the drawings are also not intended to limit the scope of the invention. Similar or different operating conditions may result in different simulation or actual observed results, for instance. It is also expected that those skilled in the art could develop other instruction formats and/or control schemes. If a series of cascaded signal filtering operations includes zero-padding, upsampling, and/or downsampling operations, for example, control information or instructions might include, in addition to filter coefficients and possibly scaling factors, other parameters such as zero-padding rates, upsampling rates, and/or downsampling rates. Like filter coefficients and scaling factors, these additional parameters could also be stored in memory elements in some implementations.

References to filter coefficients, scaling factors, and other quantities are also intended to be non-limiting. Any or all of such quantities may be considered examples of filter parameters that characterize filtering operations and that may be stored in memory, for example.

Simulation of Rayleigh fading in isotropic and nonisotropic scattering environments have been described above. A novel technique for accurate simulation of Rayleigh fading channels was proposed. Since the available filter design tools are not appropriate for designing complex filters, a new method for designing minimum phase complex IIR filters was also proposed. In addition, a specific multiplication-free filtering procedure was proposed to be utilized with fading simulators. Fixed-point numerical analysis were conducted and showed a close match between generated results and expected theoretical statistics. Two new multipurpose filter processors for baseband simulation of Rayleigh fading channels were proposed. The new processors, RFP and CFP, can be used to perform IIR filtering operations, illustratively to simulate flat-fading channels in single and multiple antenna wireless systems for isotropic and nonisotropic scattering propagation channels.

In one embodiment, a single RFP is capable of multiplication, interpolation, decimation, and performing the operations of 32 time-multiplexed filters each with up to 16 second-order sections of IIR filters or possible concatenation of IIR filters with 32-bit precision. A similar implementation of a CFP can perform the operations of 32 IIR filters with complex coefficients each with up to 16 first-order sections. One example fixed-point implementation of an RFP on a commercially available FPGA utilizes only 2% of configurable slices, 9% of dedicated multipliers and, 3.6% of available memory blocks, runs at 50 MHz, and performs the operations of one SOS in each clock cycle. With an additional 2% of configurable slices utilized for interpolation and filtering, a fading simulator can be used to generate more than 200 million samples of a Rayleigh fading process each second. Also, a parameterized mobile channel simulator can be reconfigured in some embodiments to accurately simulate a wide variety of different channel characteristics.

### REFERENCES

[1] R. H. Clarke, “A statistical theory of mobile-radio reception”, Bell Syst. Tech. J., vol 47, pp. 957-1000, July-August 1968.
[2] W. C. Jakes, Ed., Microwave Mobile Communications. New York: IEEE Press, 1974.
[3] Dent et al., “Jakes fading model revisited”, Electron. Lett., vol. 29, pp. 1162-1163, June 1993.
[4] Patzold & Laue, “Statistical properties of Jakes' fading channel simulator”, Proc. IEEE VTC 98, pp. 712-718, 1998.
[5] M. Patzold, U. Killat, F. Laue, and Y. Li, “On the statistical properties of deterministic simulation models for mobile fading channels,” IEEE Trans. Veh. Technol., vol. 47, pp. 254-269, February 1998.
[6] Y. X. Li and X. Huang, “The generation of independent Rayleigh faders,” in Proc. IEEE ICC00, p. 4145, 2000.
[7] Y. B. Li and Y. L. Guan, “Modified Jakes model for simulating multiple uncorrelated fading waveforms,” in Proc. IEEE ICC00, p. 4649, 2000.
[8] Y. X. Li and X. Huang, “The simulation of independent Rayleigh faders,” IEEE Trans. Commun., vol. 50, pp. 1503-1514, September 2002.
[9] Y. R. Zheng and C. Xiao, “Improved models for the generation of multiple uncorrelated Rayleigh fading waveforms,” IEEE Commun. Lett., vol. 6, no. 6, pp. 256-258, June 2002.
[10] Y. R. Zheng and C. Xiao, “Simulation models with correct statistical properties for Rayleigh fading channels,” IEEE Trans. Commun., vol. 51, no. 6, pp. 920-928, June 2003.
[11] M. F. Pop and N. C. Beaulieu, “Limitations of sum-of-sinusoids fading channel simulators,” IEEE Trans. Commun., vol. 49, pp. 699-708, April 2001.
[12] C. Xiao, Y. R. Zheng, and N. C. Beaulieu, “Second-order statistical properties of the WSS Jakes fading channel simulator,” IEEE Trans. Commun., vol. 50, pp. 888-891, June 2002.
[13] Stüber, Principles of Mobile Communication, New. York; Kluwer Academic Publishers, 2001.
[14] A. Salkintzis, “Implementation of a digital wide-band mobile channel simulator,” IEEE Trans. on Broadcasting, vol. 45, no. 1, pp. 122-128, 1999.
[15] M. Wickert and J. Papenfuss, “Implementation of a real-time frequency selective RF channel simulator using a hybrid DSP-FPGA architecture,” IEEE Trans. on Microwave Theory and Techniques, vol. 49, no. 8, pp. 1390-1397, 2001.
[16] A. Papoulis, Probability, Random Variables, and Stochastic Processes, New York; McGraw-Hill, 1965.
[17] P. A. Bello, “Characterization of randomly time-invariant linear channels,” IEEE Trans. Commun., vol. CS-11, pp. 360-393, December 1963.
[18] J. D. Parsons and A. S. Bajwa, “Wideband characterisation of fading mobile radio channels:” Inst. Elec. Eng. Proc., vol. 129, pt. F, no. 2, pp. 95-101, April 1982.
[19] A. Abdi, J. Barger, and M. Kaveh, “A parametric model for the distribution of the angle of arrival and the associated correlation function and power spectrum at the mobile station,” IEEE Trans. Veh. Technol., vol. 51, no. 1, pp. 425-434, May 2002.
[20] M. Abramowitz and I. Stegun, Handbook of Mathematical Functions, New York; Dover. 1965.
[21] A. Abdi, K. Wills, H. Barger, S. Alouini, and M. Kaveh, “Comparison of level crossing rate and average fade duration of Rayleigh, Rice, and Nakagami fading models with mobile channel data,” in Proc. IEEE Vehicular Technology Conf., Boston, Mass., pp. 1850-1857, 2000.
[22] C. Komninakis, “A fast and accurate Rayleigh fading simulator,” in Proc. GLOBECOM 03, Volume 6, pp. 3306-3310, 2003.
[23] K. Steiglitz, “Computer-aided design of recursive digital filters,” IEEE Trans. on Audio and Electroacoustics, vol. 18, pp. 123-129, June 1970.
[24] S. Boyd and L. Vandenberghe, Convex optimization, Cambridge University Press, 2004.
[25] L. B. Jackson, Digital Filters and Signal Processing, Kluwer Academic Publishers, 1989.
[26] A. Alimohammad, S. Fouladi Fard, B. Cockburn, and C. Schlegel, “A Compact and Accurate Gaussian Variate Generator,” to appear in IEEE Trans. on Very Large Scale Integration Systems, 2008.
[27] A. Antoniou, Digital Filters, Analysis, Design and Applications. McGraw-Hill Book Co. 1993.
[28] D. E. Goldberg, Genetic Algorithms in Search, Optimization, and Machine Learning. Addison-Wesley Professional, 1989.
[29] M. C. Jeruchim, P. Balaban, and K. S. Shanmugan, Simulation of communication systems: Modeling, methodology and techniques. New York: Kluwer Academic Publishers, 2000.
[30] D. Cox, “910 MHz urban mobile radio propagation: Multipath characteristics in New York City”, IEEE Trans. On Communications, vol. 21, pp. 1188-1194, 1973.
[31] T. S. Rappaport, Wireless Communications: Principles and Practice, Prentice Hall, 2002.
[32] T. Saramaki and J. Yli-Kaakinen, “A Novel Systematic Approach for Synthesizing Multiplication-Free Highly-Selective FIR Half-Band Decimators and Interpolators,” In Proc. of IEEE Asia Pacific Conference on Circuits and Systems (APCCAS'06), pp. 920-923, 2006.

1. A signal filtering apparatus comprising:
an element having an input and an output, the element being operable to perform a signal filtering operation on a signal received at the input so as to provide a filtered signal at the output; and
an interconnection circuit operatively coupled to the element, the interconnection circuit being controllable to switchably couple the input with the output, to thereby enable the element to be used to implement a series of cascaded signal filtering operations.

2. The apparatus of claim 1, wherein the series of cascaded signal filtering operations comprises one or more of: a zero-padding operation, an upsampling operation, and a downsampling operation.

3. The apparatus of claim 1, wherein the element is operable to perform any of a plurality of different signal filtering operations, and wherein the series of cascaded signal filtering operations comprises at least two different signal filtering operations of the plurality of different signal filtering operations.

4. The apparatus of claim 3, wherein the different signal filtering operations are associated with respective sets of one or more filter parameters, and wherein the element comprises a memory for storing the respective sets of filter parameters.

5. The apparatus of claim 4, wherein the element is controllable to perform a particular signal filtering operation of the plurality of different signal filtering operations by storing to the memory the set of filter parameters associated with the particular signal filtering operation.

6. The apparatus of claim 4, wherein the plurality of different signal filtering operations comprises a first signal filtering operation associated with a spectrum shaping filter (SSF) and a second filtering operation associated with a low-pass filter (LPF).

7. The apparatus of claim 6, wherein a filtering process of the SSF comprises repeating the first filtering operation a number of times, and wherein a filtering process of the LPF comprises repeating the second signal filtering operation a number of times.

8. The apparatus of claim 6, wherein the SSF operates at a sample rate Fₛ₁ and the LPF operates at a sample rate Fₛ₂ that is an integral multiple, I₁, of Fₛ₁, and wherein the element is used to perform the second signal filtering operation I₁ times for each time the element is used to perform the first signal filtering operation.

9. The apparatus of claim 6, wherein the SSF and the LPF are operable to together provide desired filtering characteristics.

10. The apparatus of claim 1, wherein the element comprises a filter second-order section (SOS) or filter first-order section hardware (FOSH).

11. The apparatus of claim 1, wherein the element and the interconnection circuit are controlled in accordance with software instructions.

12. The apparatus of claim 11, wherein the software instruction comprises a count field and a mode field, the mode field specifying whether or not a wait operation during which a value in the count field is to be counted down to zero is to be executed, and the count field comprising at least one of: an opcode field specifying an operation to be executed when a wait operation is not to be executed, a program counter field specifying a program counter value, a multiplexer select field for specifying multiplexer select lines, a multiplier number identifying a multiplier, a biquad number identifying a biquad, and a filter number identifying a filter.

13. The apparatus of claim 1, wherein the interconnection circuit comprises:
a multiplexer operatively coupled to receive the filtered signal and an input signal, and to provide the input signal or the filtered signal to the input of the element.

14. The apparatus of claim 1, implemented onto a Field Programmable Gate Array (FPGA).

15. A fading communication channel emulator comprising:
the apparatus of claim 1; and
a Gaussian variate generator (GVG) operatively coupled to the interconnection circuit.

16. The fading channel emulator of claim 15, further comprising:
a low-pass filter operatively coupled to the apparatus, the low-pass filter being operable to further filter an output of the apparatus.

17. The fading channel emulator of claim 16, wherein the low-pass filter comprises a number of zero-order hold filters.

18. The fading channel emulator of claim 16, further comprising:
an elastic buffer between the apparatus and the low-pass filter.

19. The fading channel emulator of claim 15, further comprising:
a plurality of low-pass filters operatively coupled together in series and to the apparatus, the plurality of low-pass filters being operable to further filter an output of the apparatus; and
a respective elastic buffer operatively coupled to an output of each low-pass filter of the plurality of low-pass filters.

20. The fading channel emulator of claim 19, wherein the apparatus and the plurality of low-pass filters exchange handshaking information.

21. A signal filtering method comprising:
providing an element that is operable to generate a filtered signal by performing a signal filtering operation on a signal received at an input; and
selecting, from a set of signals comprising a filter input signal and the filtered signal, an input to the element, to enable the element to be used to perform a series of cascaded signal filtering operations.

22. The method of claim 21, wherein the set of signals further comprises a zero signal, and wherein the series of cascaded signal filtering operations comprises one or more of: a zero-padding operation, an upsampling operation, and a downsampling operation.

23. The method of claim 21, wherein the element is operable to perform any of a plurality of different signal filtering operations, and wherein the series of cascaded signal filtering operations comprises at least two different signal filtering operations of the plurality of different signal filtering operations.

24. The method of claim 23, wherein the different signal filtering operations are associated with respective sets of one or more filter parameters, the method further comprising:
selecting a particular signal filtering operation of the plurality of different signal filtering operations; and
providing to the element the set of filter parameters associated with the particular signal filtering operation.

25. The method of claim 23, wherein the plurality of different signal filtering operations comprises a first signal filtering operation associated with a spectrum shaping filter (SSF) and a second filtering operation associated with a low-pass filter (LPF).

26. The method of claim 25, wherein a filtering process of the SSF comprises repeating the first filtering operation a number of times, and wherein a filtering process of the LPF comprises repeating the second signal filtering operation a number of times.

27. The method of claim 21, wherein the element comprises a filter second-order section (SOS) or filter first-order section hardware (FOSH).

28. The method of claim 21, wherein selecting comprises selecting an input from the set of signals in accordance with a software instruction.

29. The method of claim 21, wherein the filter input signal comprises a series of samples generated by a Gaussian variate generator (GVG).

30. The method of claim 29, further comprising:
providing an output of the series of cascaded filtering operations to a low-pass filter.

31. A method comprising:
designing a signal filter to implement a desired filter frequency response; and
performing an iterative optimization procedure on the signal filter to achieve an acceptable level of similarity between an actual frequency response of the signal filter and the desired filter frequency response.

32. The method of claim 31, wherein designing comprises selecting a number of filter sections for the signal filter, and wherein the iterative optimization procedure comprises changing the number of filter sections.

33. The method of claim 32, wherein the signal filter comprises multiple cascaded signal filters, wherein designing comprises selecting a common number of filter sections for each of the multiple filters, and wherein the iterative optimization procedure comprises changing the common number of filter sections.

34. The method of claim 31, wherein the signal filter is associated with filter parameters, and wherein the iterative optimization procedure comprises adjusting the filter parameters.

35. The method of claim 34, wherein adjusting the filter parameters comprises calculating the filter parameters using the following Algorithm:
$Require \text{:} t ; L ; v = [ {v}_{i} ] , {y}^{d} = [ {y}_{i}^{d} ] , i = 0 … 2 M - 1$ $Initialize k = 0 , {x}_{0} , {E}_{0} = 20 {I}_{8 K \times 8 K}$ $while not converged do$ $find {A}_{k}^{o} = {\prod }_{i = 0}^{2 M - 1} {( \frac{{y}_{i}^{d}}{\vert F ( x ; {e}^{- j 2 π {u}_{i}} ) \vert} )}^{\frac{{v}_{1}}{{\sum }_{i = 0}^{2 M - 1} {v}_{i}}}$ $find {g}_{k} = g ( {A}_{k}^{o} , {x}_{k} ) from g ( {A}^{o} , x ) = {[ \frac{\partial q ( {A}^{o} , x )}{\partial {x}_{1}} , … , \frac{\partial q ( {A}^{o} , x )}{\partial {x}_{8 K}} ]}^{T} and$ $\frac{\partial q ( {A}^{o} , x )}{\partial {x}_{k}} = 2 {\sum }_{i = 0}^{2 M - 1} [ \frac{{v}_{i} log ( \frac{{A}^{o} \vert F ( x ; {e}^{- j {ω}_{i}} ) \vert}{{y}_{i}^{d}} )}{\vert F ( x ; {e}^{- j {ω}_{i}} ) \vert} ] \frac{\partial \vert F ( x ; {e}^{- j {ω}_{i}} ) \vert}{\partial {x}_{k}} + \frac{\partial B ( L ; t ; x )}{\partial {x}_{k}}$ ${β}_{k} = \sqrt{{g}_{k}^{T} {E}_{k} {g}_{k}}$ ${\tilde{g}}_{k} = {g}_{k} / {β}_{k}$ ${x}_{k + 1} = {x}_{k} - \frac{1}{8 K + 1} {E}_{k} {\tilde{g}}_{k}$ ${E}_{k + 1} = \frac{{( 8 K )}^{2}}{{( 8 K )}^{2} - 1} ( {E}_{k} - \frac{2}{8 K + 1} {E}_{k} {\tilde{g}}_{k} {\tilde{g}}_{k}^{T} {E}_{k} )$ $k = k + 1$ $end while$
where
t is an outer boundary for poles and zeros;
v=[vᵢ] is a weight vector;
y^{d}=[yᵢ^{d}] is a vector containing the desired filter response;
2M is a number of frequency points in uᵢε[−0.5,+0.5] over which the actual frequency response of the signal filter is fit to the desired filter frequency response;
x is a column vector of length 8K containing rₖ, sₖ, θₖ, and φₖ;
rₖe^{jθ}^{ₖ} and sₖe^{hφ}^{ₖ} are the k th complex zero and pole of
$$H ( {e}^{- jω} ) = A {\prod }_{k = 1}^{2 K} \frac{1 - {r}_{k} {e}^{j ( {θ}_{k} - ω )}}{1 - {s}_{k} {e}^{j ( {φ}_{k} - ω )}} = A \times F ( x , {e}^{- jω} ) ;$$
A is a positive scaling factor;
E is an ellipsoid matrix;
Aₖ^{o} is an optimal scaling factor;
g(A^{o}, x) is a gradient vector;
ωᵢ=2πuᵢ;
$$B ( L , t , x ) = {\sum }_{k = 1}^{4 K} b ( L ; t ; {x}_{k} )$$
is a barrier function;
$$b ( L ; t ; {x}_{k} ) = \{ \begin{matrix}0 & if \vert {x}_{k} \vert \leq t , \\ {L ( \frac{\vert {x}_{k} \vert - t}{1 - t} )}^{2} & if t < \vert {x}_{k} \vert \leq 1 , \\ \frac{2 L}{1 - t} \vert {x}_{k} \vert - L ( \frac{1 + t}{1 - t} ) & if \vert {x}_{k} \vert \geq 1. ;\end{matrix}$$
L determines how quickly the barrier function grows outside the unit circle; and
2K is a number of first-order sections in the signal filter.

36. A computer-readable medium storing a data structure, the data structure comprising:
a plurality of data fields storing control information for controlling operation of at least one of: an element that is operable to generate a filtered signal at an output by performing a signal filtering operation on a signal received at an input, and an interconnection circuit that is operatively coupled to the element for switchably coupling the input with the output,
the data fields enabling the element and the interconnection circuit to be used to perform a series of cascaded signal filtering operations.

37. The medium of claim 36, wherein the plurality of data fields comprises a data field identifying the element and a data field indicating an operation to be performed by the element.

38. The medium of claim 36, wherein the plurality of data fields comprises a data field identifying a component of the interconnection circuit and a data field indicating an operation to be performed by the identified component.

39. The medium of claim 36, wherein the plurality of data fields comprises a mode data field, the mode data field indicating how other data fields of the plurality of data fields are to be processed.

40. A signal filtering apparatus comprising:
an element having an input and an output, the element being operable to perform any of a plurality of signal filtering operations on a signal received at the input, the plurality of signal filtering operations being associated with respective sets of filter parameters; and
a controller operatively coupled to the element and operable to control selection of the respective sets of filter parameters for use by the element, to thereby enable the element to be used to implement the plurality of signal filtering operations in respective parallel filtering paths.

41. The apparatus of claim 40, wherein the plurality of signal filtering operations and the respective sets of filter parameters correspond to respective communication signal propagation paths.

42. The apparatus of claim 40, further comprising:
a memory, operatively coupled to the element and to the controller, for storing the respective sets of filter parameters.

43. The apparatus of claim 42, wherein the controller controls selection of the respective sets of filter parameters by controlling addresses in the memory from which filter parameters are provided to the element.

44. The apparatus of claim 40, wherein the element comprises one of a plurality of elements operatively coupled together in series.

45. The apparatus of claim 44, wherein the elements are operatively coupled together through elastic buffers.

46. The apparatus of claim 44, wherein each element of the plurality of elements is operatively coupled to a respective controller, and wherein the controller of an element is operatively coupled to, and exchanges handshaking information with, a controller of each adjacent element.

47. A signal filtering method comprising:
providing an element that is operable to perform any of a plurality of signal filtering operations on a signal received at an input, the plurality of signal filtering operations being associated with respective sets of filter parameters; and
controlling selection of the respective sets of filter parameters for use by the element, to thereby enable the element to be used to implement the plurality of signal filtering operations in respective parallel filtering paths.

48. The method of claim 47, wherein the plurality of signal filtering operations and the respective sets of filter parameters correspond to respective communication signal propagation paths.

49. The method of claim 47, wherein the respective sets of filter parameters are stored in a memory, and wherein controlling comprises controlling selection of the respective sets of filter parameters by controlling addresses in the memory from which filter parameters are provided to the element.

50. The method of claim 47, wherein providing comprises providing a plurality of elements, including the element, operatively coupled together in a series of stages, the method further comprising:
exchanging handshaking information between the stages,
wherein controlling at each stage following a first stage in the series comprises controlling selection of the respective sets of filter parameters based on handshaking information received from a preceding stage.
